(19) United States
(12) Patent Application Publication
(10) Pub. No.: US 2007/0288435 A1
(43) Pub. Date: Dec. 13, 2007

(54) IMAGE STORAGE/RETRIEVAL SYSTEM, IMAGE STORAGE APPARATUS AND IMAGE RETRIEVAL APPARATUS FOR THE SYSTEM, AND IMAGE STORAGE/RETRIEVAL PROGRAM

(76) Inventors: Manabu Miki, Ibaraki-shi (JP); Motohide Umano, Osaka-shi (JP)

Correspondence Address: James G. O'Neill;Klein, O'Neill & Singh LLP, Suite 204, 43 Corporate Park, Irvine, CA, 92606, US

(21) Appl. No.: 11/746,402

(22) Filed: May 9, 2007

(30) Foreign Application Priority Data
May 10, 2006 (JP) 2006-130953

(51) Int. Cl. G06F 17/30

(52) U.S. Cl. 707/3

(57) ABSTRACT

An image storage apparatus comprises: a photograph information analysis processor for outputting photograph information perception data quantitatively associated with perception terms (language) relating to photograph images; and a color perception analysis processor for outputting color perception data quantitatively associated with perception terms relating to colors of the images. The output data are stored in the storage apparatus. When receiving search terms of photograph information and color perceptions of retrieval target images, an image retrieval apparatus compares the search terms with image content language data stored in the storage apparatus to narrow the language data, and extracts images in descending order of priority (scores) of the perception terms corresponding to the search terms with reference to photograph information and color perception data attributed to the retrieval target images and including the narrowed language data. Images best meeting the perception requirements of users can be stored and retrieved accurately at high speed.

### BACKGROUND OF THE INVENTION

1. Field of the Invention

The present invention relates to an image storage apparatus for storing data corresponding to photograph information of images, an image retrieval apparatus for retrieving a desired image from the data stored in the image storage apparatus, an image storage/retrieval system comprising the image storage apparatus and the image retrieval apparatus as well as an image storage/retrieval program.

2. Description of the Related Art

As digital cameras have become popular, a huge amount of digital images are stored on the internet and local personal computers. Normally, images stored on local personal computers are used by creators of the images, so that such images are often not provided with text (language) information such as keywords or search words and are not in order. Thus, such images are not sufficiently used by users other than the creators, although data such as photographing date/time and shutter speed are provided (attached) to the images, even unintentionally, because commercially available digital cameras use Exif (Exchangeable Image File Format) as a common standard for providing metadata of photographing conditions.

On the other hand, regarding photographs on the internet, photograph images are usually commonly owned on the internet, so that text information, called tag, is often actively provided (attached) to the photograph images for users other than creators. Under these circumstances, various retrieval methods have been proposed to retrieve images desired by users, taking into account a feature of each image, such as a retrieval method based on text information (title, search word and the like) provided (attached) to each image and representing a feature of the image, a retrieval method based on similarity of feature information (color, shape and the like) of each image, and a combined retrieval method using the combination of these two retrieval methods as described in Japanese Laid-open Patent Publications Hei 5-94478, Hei 1-231124, Hei 11-39317 and Hei 7-146871, which will also be described below.

The technology disclosed in Japanese Laid-open Patent Publication Hei 5-94478 focuses on adjectives and adverbs in a text (language) or search (retrieval) terms, because a feature of an image and a text representing the feature are basically qualitative, and because adjectives and adverbs represent the qualitative nature. According to this technology, such adjectives and adverbs are incorporated into multiple keywords or search terms (nouns and verbs, or a natural language text) so as to retrieve an image based on the presence of a feature quantity (value or information) of image data corresponding to qualitative terms (“big”, “considerably”, etc.) other than nouns. However, although this technology enables the use of adjectives and adverbs other than nouns as search terms, it does not quantify best features of photographed images such as photographing conditions and color levels. This causes the retrieval accuracy to be very bad (low), making it difficult to retrieve an image desired by a user from a huge amount of image data.

The technology disclosed in Japanese Laid-open Patent Publication Hei 1-231124 calculates level or degree (score) of an adjective representing a feature of each image such as “cool” or “warm”, and quantifies the adjective using a probability distribution function in order to enable more accurate and more quantitative retrieval of images based on adjectives. However, this quantification is based on an impression of each image in its entirety determined by a human observer, so that it lacks objectivity, and requires quantifying the images, image-by-image. Thus, this technology causes inaccurate image retrieval, and requires a huge time to create a huge amount of image database.

The technology disclosed in Japanese Laid-open Patent Publication Hei 11-39317 focuses on “shape and color information” as features of images so as to create an image database, and retrieve an image from the image database. According to this technology, a shape in an image is extracted, and a representative color information in the shape is treated as a feature quantity (value or information), in which a correspondence table between objects and colors is made through experiments so as to be used to retrieve a desired image based on the correspondence table. Thus, this technology requires a complicated processing to be performed. In addition, the retrieval based on color information according to this technology does not enable image retrieval adapted to complex and profound (sophisticated) color representation which a human being basically has.

The technology disclosed in Japanese Laid-open Patent Publication Hei 7-146871 extracts the RGB (red, green and blue) components within a mesh region in an image so as to calculate a representative value therein, and then to retrieve a color without clearly defining the name of the color, maintaining ambiguity. However, this technology makes it difficult to retrieve an image desired by a user, because it handles color in the mesh region only by the representative value, and quantifies the color without using perception (perceptual) quantity which the user, or human being, basically has on the image.

Here, it is to be noted that the feature of human perceptual recognition of an image in its entirety is that it is based on color level, photographing time, photographing location and so on rather than on shape, and is not simple, but profound and comprehensive. For example, Japanese language and English language have about 2,130 recorded words and 7,500 recorded words, respectively, that represent various colors with perceptual features, such as color perception terms (language), time perception terms and location perception terms. Thus, under the background described above, it is desired that an image with a feature quantity (information) obtained by quantification suitable for such perceptual terms can be retrieved from a huge amount of image database which exists on the internet and/or many image computers.

### SUMMARY OF THE INVENTION

An object of the present invention is to provide an image storage/retrieval system, an image storage apparatus and an image retrieval apparatus for the system as well as an image storage/retrieval program that can analyze an input image with respect to physical quantities (values) so as to automatically extract image perception data which are quantitatively evaluated and associated with photograph information and color perception language (terms), and so as to store the image perception data as a database, so that images best meeting the perception requirements of a user can be stored and retrieved accurately at a high speed.

According to a first aspect of the present invention, the above object is achieved by an image storage/retrieval system comprising an image storage apparatus and an image retrieval apparatus, wherein the image storage apparatus comprises: an image input unit for receiving a photographed image data and outputting an output signal of the image data; an image content language input unit for inputting language data (hereafter referred to as “image content language data”) indicating content of an image; an image content language data storage unit for storing the image content language data input by the image content language input unit; a photograph information analysis unit for analyzing the output signal of the image input unit so as to output data (hereafter referred to as “photograph information perception data”) quantitatively associated with predetermined perception language relating to photograph information; a photograph information perception data storage unit for storing the photograph information perception data; a color perception analysis unit for analyzing the output signal of the image input unit so as to output data (hereafter referred to as “color perception data”) quantitatively associated with predetermined perception language relating to colors; a color perception data storage unit for storing the color perception data; and an image data storage unit for storing image data corresponding to the image content language data, the photograph information perception data and the color perception data, and

On the other hand, the image retrieval apparatus comprises: a search language input unit for inputting language (hereafter “search language”) for search and retrieval; an image content language data narrowing unit coupled to the image storage apparatus for comparing the image content language data stored in the image content language data storage unit with the search language input from the search language input unit so as to extract image content language data at least partially matching the search language; and an image data output unit for extracting and outputting images stored in the image data storage unit in descending order of priority of perception language corresponding to the search language with reference to the photograph information perception data and the color perception data attributed to retrieval target images and including the image content language data narrowed by the image content language data narrowing unit.

According to the image storage/retrieval system of the first aspect of the present invention, image content language data (such as content description text), photograph information perception data (such as photographing date/time and location) and color perception data for each of input images are quantified and stored in the storage units of the image storage apparatus. Using search language input to the image retrieval apparatus as search keys, target images are narrowed with reference to the image content language data. Further, resultant images are extracted and output in descending order of priority of the search language with reference to the photograph information perception data and the color perception data. Thus, even if the image search/retrieval was performed using an ambiguous or fuzzy natural language text, images meeting the perception requirements of users can be extracted and retrieved.

More specifically, the image storage apparatus can convert images input from the image input unit such as a digital camera to physical quantities so as to make it possible to automatically produce image database based on perception quantities of users, so that the production can be done securely and inexpensively. If users use or input perception language (image perception language for photograph information and colors) which can readily remind the users of features of images, such as photographing date/time, photographing location, photographing (camera) conditions and accustomed terms to which the users are accustomed for a long time, it becomes possible for the users to easily, readily and quickly retrieve desired images. For example, by quantifying physical quantities of photographed images, such as Exif and RGB values, to score data corresponding to the image perception language, desired or target images can be retrieved from a huge amount of image database at fast speed.

Preferably, the image retrieval apparatus further comprises a morphological analysis unit for parsing the language input from the search language input unit into, and outputting, terms as search keys, wherein: the image content language narrowing unit compares the image content language data with the search keys output by the morphological analysis unit so as to narrow retrieval target data and output narrowed retrieval target data; and the image data output unit comprises an image perception data reordering unit for reordering the output narrowed retrieval target data for each image perception data corresponding to the search language so as to display the images according to result of the reordering. This makes it possible to use a natural language text or terms input by users to narrow information of images stored in the image storage apparatus, thereby enabling extraction and retrieval of images meeting the perception requirements of the users.

Further preferably, the image retrieval apparatus further comprises a synonym extraction processor and/or a relevant term extraction processor for extracting, from a thesaurus dictionary, information of synonyms of the search keys and/or relevant terms of the search keys output by the morphological analysis unit, and for adding the extracted information as the search keys. This makes it possible to expand the range of retrieval of images based on natural language, thereby enabling extraction and retrieval of more images meeting the perception requirements of the users.

Further preferably, the photograph information analysis unit analyzes the output signal of the image input unit so as to output photograph information perception data including photograph information perception language data and a photograph information perception score, wherein the color perception analysis unit analyzes the output signal of the image input unit so as to output color perception data including color perception language data and a color perception score. This makes it possible to manage and store individual perception information of images needed for retrieval in terms of the combination of perception language and perception scores calculated by quantifying perception quantities.

Further preferably, the color perception analysis unit has a color perception function to calculate a color perception score corresponding to each color perception language, and allows the color perception function to be modified for adaptation to a color corresponding to compound color perception language in a same color perception space. This makes it possible to modify or change the combination of color perception function of each color perception space so as to modify psychological color perception quantity (value), whereby more detailed color perception scores can be calculated corresponding to compound or combination of color perception terms, thereby making it possible to retrieve compound color images. For example, some compounds of “red”, such as “true red”, “reddish” and “red-like”, vary in their positions of boundary (threshold) values in the color perception space of “red”. Appropriate color perception scores in this case can be calculated by modifying or changing the color perception function in the quantification according to the (degree of) psychological quantities corresponding to the compounds.

Further preferably, the color perception analysis unit modifies the color perception function depending on quantity and degree of integration of colors contained in image and on position in image plane. This makes it possible to modify or change the color perception function depending on the quantity and degree of integration of analogous colors and on position in image plane, so as to accurately express a difference in color perception quantity in an image. The color perception quantity of “red” varies with the degree of integration of analogous colors and with position in image. The quantity of analogous colors can be calculated by measuring a color which has color perception scores corresponding to each perception language over a certain sufficient amount of area of an image (screen). Further, the degree of integration of analogous colors can be calculated by dividing the screen into multiple sections, and by measuring each color which has color perceptions scores over a certain sufficient amount of area of each section of the screen. Furthermore, a difference of position in image plane can be obtained by dividing the screen into multiple sections, and give different weightings to the central portion and peripheral portion of the screen. In this way, images of analogous colors can be retrieved.

Each of the image storage apparatus per se and the image retrieval apparatus per ser to be used in the image storage/retrieval system is also a subject of the present invention.

According to a second aspect of the present invention, the above-described object is achieved by an image storage/retrieval program for an image storage/retrieval system comprising an image storage apparatus and an image retrieval apparatus each having a computer, wherein the image storage/retrieval program allows the image storage apparatus to execute: an image input step for inputting a photographed image data to an image input unit; a data storing step for storing image content language data indicating content of an image input from an image content language input unit in an image content language data storage unit; a photograph information analyzing step for analyzing an output signal of the image input unit so as to output photograph information perception data quantitatively associated with predetermined perception language relating to photograph information; a photograph information perception data storing step for storing the photograph information perception data in a photograph information perception data storage unit; a color perception analyzing step for analyzing the output signal of the image input unit so as to output color perception data quantitatively associated with predetermined perception language relating to colors; a color perception data storing step for storing the color perception data in a color perception data storage unit; and an image data storing step for storing, in an image data storage unit, image data corresponding to the image content language data, the photograph information perception data and the color perception data.

On the other hand, the image storage/retrieval program allows the image retrieval apparatus to execute: a search language input step for inputting search language for search and retrieval; an image content language data narrowing step for comparing the image content language data stored in the image content language data storage unit with the search language input from the search language input unit so as to extract image content language data at least partially matching the search language; and an image data output step for extracting and outputting images stored in the image data storage unit in descending order of priority of perception language corresponding to the search language with reference to the photograph information perception data and the color perception data attributed to retrieval target images and including the image content language data narrowed by the image content language data narrowing step.

This image storage/retrieval program exerts effects similar to those exerted by the image storage/retrieval system according to the first aspect of the present invention.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. Note that all the drawings are shown to illustrate the technical concept of the present invention or embodiments thereof, wherein:

FIG. 1 is a schematic block diagram of an image storage/retrieval system according to an embodiment of the present invention;

FIG. 2 is a flow chart of an image storage process of an image storage apparatus;

FIG. 3 is a detailed flow chart of a photograph information analysis step;

FIG. 4 is a graph for acquiring photograph year/month/date, time perception terms and perception scores from Exif data used for the photograph information analysis step;

FIG. 5 is a graph for acquiring time perception scores of “spring”;

FIG. 6 is a detailed flow chart of a color perception analysis step;

FIG. 7 is a schematic view of color perception space showing color perception quantity in a three-dimensional HSI color space to be used for the color perception analysis step;

FIG. 8 is a schematic chart of a portion of a two-dimensional plane of saturation and hue in a cross-section of the color perception space to be used for color perception analysis;

FIG. 9 is a graph of color perception score curves of saturation (on the left: saturation perception score vs. saturation value) and hue (on the right: hue perception score vs. hue value), under the same intensity;

FIG. 10 is a chart showing a method for quantifying color perception quantity corresponding to a color perception term of saturation of green under a constant intensity;

FIG. 11 is a graph of an example of correction of color perception score by color weighting, showing a method of converting the color perception score according to color perception language;

FIG. 12 is a graph of an example of correction of color perception score;

FIG. 13 is a chart showing a method for calculating a color perception score of a pixel according to a position of the pixel in image plane;

FIG. 14 is a flow chart of an image retrieval process:

FIG. 15 is a chart showing processes of displaying retrieval images for three kinds of natural language texts (a), (b) and (c);

FIG. 16 is a relationship chart used to search and retrieve an image(s) using search language as a search key; and

FIG. 17 is a schematic block diagram of a network structure of an image storage/retrieval system according to an embodiment of the invention.

### DESCRIPTION OF THE PREFERRED EMBODIMENTS

Embodiments of the present invention, as best mode for carrying out the invention, will be described hereinafter with reference to the drawings. It is to be understood that the embodiments herein are not intended as limiting, or encompassing the entire scope of, the invention. Note that like parts are designated by like reference numerals or characters throughout the drawings.

(Structure of Image Storage/Retrieval System)

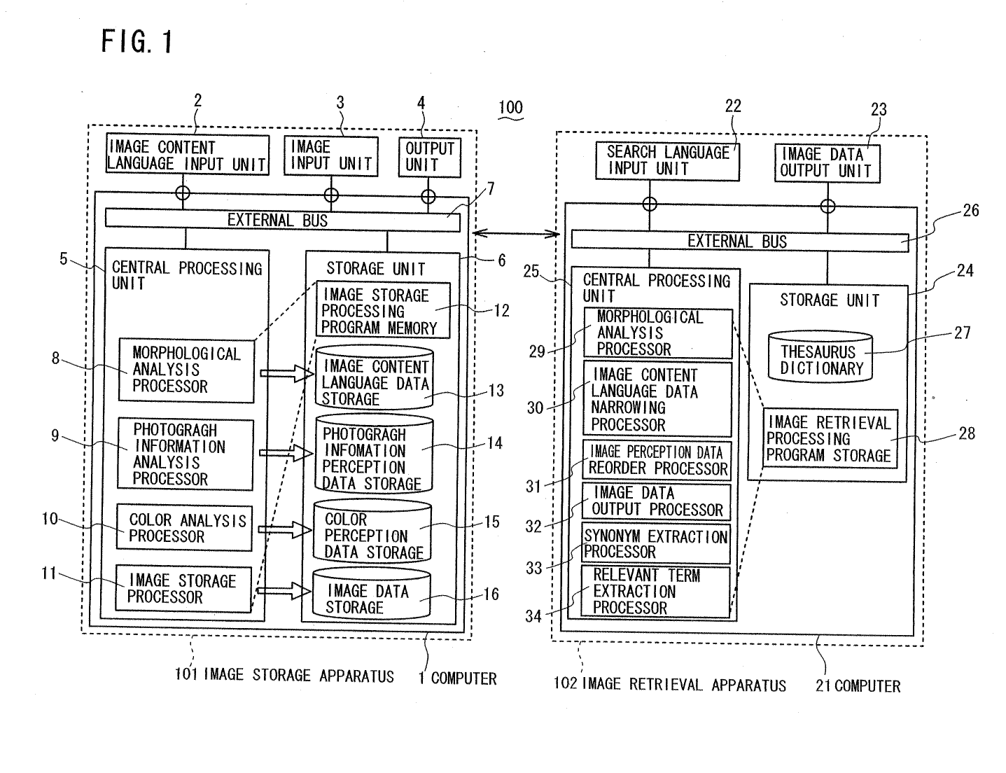

Hereinafter, an image storage/retrieval system 100 according to an embodiment of the present invention will be described with reference to the drawings. FIG. 1 is a schematic block diagram of the image storage/retrieval system 100 comprising an image storage apparatus 101 and an image retrieval apparatus 102 which are connected to each other to communicate with each other. Each of the image storage apparatus 101 and the image retrieval apparatus 102 will be described below.

(Structure of Image Storage Apparatus)

The image storage apparatus 101 comprises a computer 1, an image content language (term(s) or text) input unit 2, an image input unit 3 and an output unit 4. The computer 1 comprises: a central processing unit 5 formed of a calculation unit and a processing unit; a storage unit 6 formed of a secondary storage such as a hard disk, an optical disc or a floppy disk for storing programs and databases, and of a main memory for reading e.g. the programs so as to perform processing based on signals received from outside; and an external bus 7. The central processing unit 5 comprises: a morphological analysis processor (unit) 8 for parsing or dividing input image content language (term(s) or text) data into terms according to parts of speech; a photograph information analysis processor (unit) 9 (photograph information analysis unit) for reading photograph information contained in Exif (Exchangeable Image File Format) data provided (attached) to images, and evaluate and associate the read information with photograph information perception language so as to provide perception scores to the images based on the evaluation; a color analysis processor (unit) 10 (color perception analysis unit) for providing, to respective pixels contained in each image, perception scores associated with color perception language; and an image storage processor 11 for storing input image data.

The storage unit 6 comprises: an image storage processing program storage 12 for storing a morphological analysis program, a photograph information analysis program and a color analysis program; an image content language (terms) data storage 13 for storing output results of the morphological analysis processor 8; a photograph information perception data storage 14 for storing output results of the photograph information analysis processor 9; a color perception data storage 15 for storing output results of the color analysis processor 10; and an image data storage for storing images input from the image input unit 3. Any computers such as a personal computer, a server and a workstation can be used as the computer 1. The image content language input unit 2 is formed of a mouse, a keyboard, an electronic pen input device, a word processor, a tablet and/or the like. The image input unit 3 is formed of a USB (Universal Serial Bus) connected digital camera, a memory card (e.g. Memory Stick and SD Memory Card), a digital scanner and/or the like. Examples of the output unit 4 are a CRT (cathode ray tube), a PDP (plasma display panel) and an LCD (liquid crystal display).

(Structure of Image Retrieval Apparatus)

The image retrieval apparatus 102 comprises a computer 21, a search (retrieval) language (term(s) or text) input unit 22 and an image data output unit 23. The computer 21 comprises: a storage unit 24 formed of a secondary storage such as a hard disk, an optical disc or a floppy disk for storing programs and databases, and of a main memory for reading e.g. the programs so as to perform processing based on signals received from outside; a central processing unit 25 formed of a calculation unit and a processing unit; and an external bus 26. The storage unit 24 comprises a thesaurus dictionary 27; and an image retrieval processing program storage 28 for storing a morphological analysis program, an image content language (term(s) or text) data narrowing program, an image perception data reordering program, a synonym extraction program and a relevant term extraction program.

The central processing unit 25 comprises: a morphological analysis processor (unit) 29 for parsing or dividing input search (retrieval) language (term(s) or text) data into terms according to parts of speech; an image content language data narrowing processor 30 (image content language data narrowing unit) coupled to the image storage apparatus 101 for extracting and retrieving (outputting), from the image content word data storage 13 of the image storage apparatus 101, image content language data which fully (with full text) or partially (i.e. at least partially) match one or multiple terms (search language or terms or keywords) produced by the morphological analysis processor 29 based on the parsing; and an image perception data reordering processor (unit) 31 for extracting, from the photograph information perception data storage 14 and the color perception data storage 15 of the image storage apparatus 101, photograph information perception data and color perception data respectively including perception scores and corresponding to the one or multiple terms produced by the morphological analysis processor 29 based on the parsing so as to reorder the photograph information perception data and the color perception data in descending order of perception score (i.e. descending order of priority from highest priority to lowest).

The central processing unit 25 further comprises: an image data output processor 32 (image data output unit) for acquiring, from the image data storage 16 of the image storage unit 101, image data corresponding to the thus narrowed and reordered image perception data so as to display such image data; a synonym extraction processor 33 for extracting a synonym from the thesaurus dictionary 27 stored in the storage unit 24 without waiting for, or receiving, input of additional search language (term) data (new natural language text) from the search language input unit 22, so as to widen the search (retrieval) results; and a relevant term extraction processor 34 for extracting relevant terms. As for the computer 21, computers similar to the computer 1 described above can be used, while as for the search language input unit 22, similar units to the image content language input unit 2 described above can be used. The search language (term or terms) to be input can be a natural language text (sentence) or a series of discrete terms. The input natural language text or terms are parsed (divided or classified) into multiple parts of speech such as nouns and adjectives so as to be sent to the image content language data narrowing processor 30. An output unit similar to the output unit 4 described above can be used as the image data output unit 23.

(Description of Function of Image Storage Apparatus)

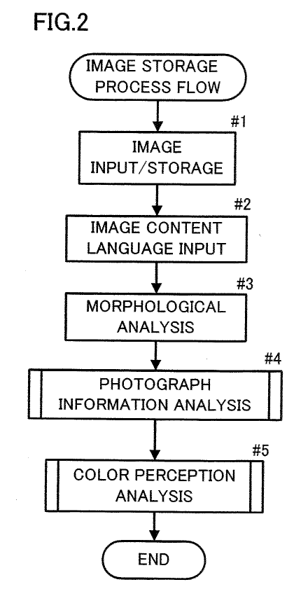

Referring now to FIG. 2 to FIG. 14, the function of the image storage apparatus 101 will be described below. FIG. 2 is a flow chart of an image storage process of the image storage apparatus 101. The image storage process comprises steps of image input/storage (#1), image content language input (#2), morphological analysis (#3), photograph information analysis (#4) and color perception analysis (#5). The latter four steps (#2 to #5) can be performed concurrently with the image input/storage step (#1). First, the image input/storage step (#1) is performed by allowing the storage unit 6 to store signals output from the image input unit 3 driven by the image storage processor 11, namely, a digital image and its photographing condition information. The photographing condition information includes Exif (Exchangeable Image File Format) data. Further, location data from GPS (Global Positioning System), which can identify the location where the photographing was done, is also one of the photographing condition information.

The image content language input step (#2) and the morphological analysis step (#3) are performed by the morphological analysis processor 8 when a user operates the image content language input unit 2 to input language (term(s) or text) data to the central processing unit 5 via the external bus 7. Data input from the image content language input unit 2 includes a name of a photographer or creator of an image, a title of the image and a description text describing features of the image. Such input data is parsed into multiple parts of speech such as a noun and an adjective, which are then stored in the image content language data storage 13. The input data can be a natural language text (sentence) or a series of discrete terms. The photograph information analysis step (#4) is performed by allowing the photograph information analysis processor 9 to analyze signals output from the image input unit 3 so as to acquire photograph information perception data. The photograph information perception data includes three kinds of data that are location perception data about photographing location, time perception data about photographing time, and photographing condition data about photographing condition. Each of these perception data is composed of two kinds of data, i.e. perception language (term) and perception score.

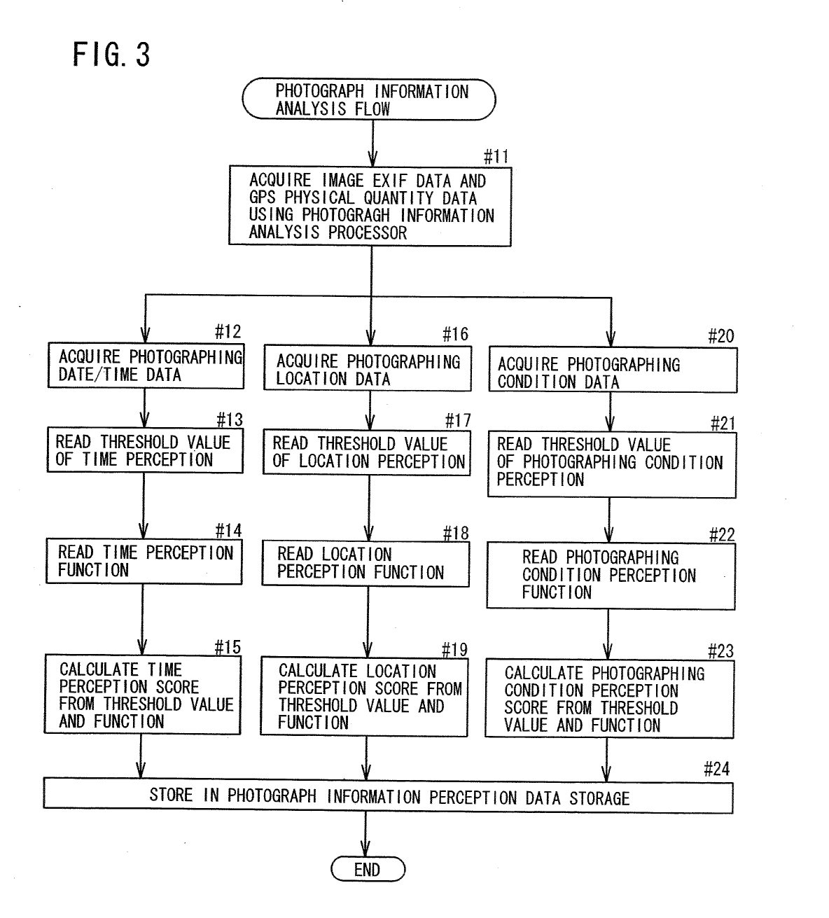

FIG. 3 is a detailed flow chart of the photograph information analysis step (#4). The photograph information analysis step (#4) comprises a step of acquiring image Exif and GPS physical quantity (value) data using the photograph information analysis processor 9 (#11) for analysis, and steps of: extracting and acquiring data about time (date and, if necessary, time), data about location and data about photographing condition (as well as other data if necessary); extracting and calculating a perception language (term) and its perception score corresponding to each of such data (such steps correspond to conversion of such data to respective photograph information perception data) (#12 to #15, #16 to #19, and #20 to #23, respectively); and storing these data in the photograph information perception data storage 14 (#24).

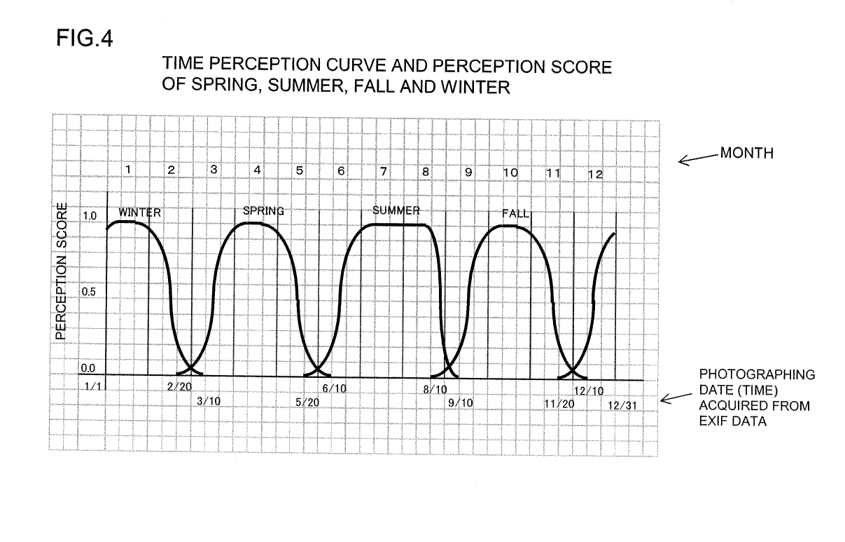

First, the time perception data in the photograph information analysis process (#4) will be described. Time perception terms (language) are those which are usually used to recognize time, in which terms belonging to the time perception data include seasonal terms such as spring and rainy season, and monthly terms such as early, middle and late parts of each month. FIG. 4 is a graph for associating photograph year/month/date information in the Exif data with time perception terms and their perception scores, that is a graph for acquiring photograph year/month/date, time perception terms and perception scores from the Exif data used for the photograph information analysis step (#4). Here, a time perception of each season is quantified by a perception score from value 0.0 to value 1.0, where the value 0.0 represents time when the season is not perceived (felt), while the value 1.0 represents time when the season is most strongly perceived (felt). Thus, both values 0.0 and 1.0 are boundary (threshold) values. On the other hand, other in-between levels of time perception are quantified by a time perception function to calculate time perception quantities (values) between value 0.0 and value 1.0.

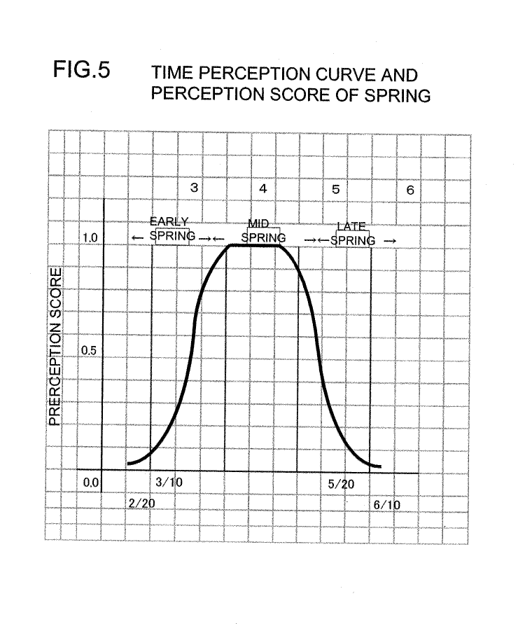

FIG. 5 is a time perception curve in which time perception scores and dates are associated with each other for the perception term “spring”, that is a graph for acquiring time perception scores of “spring”. In association with the perception term “spring”, the period from February 20 (2/20) to June 10 (6/10) is assumed as a time perception range in which it is “perceived as spring”, and in which the perception quantity (value or level) to allow it to be “perceived as spring” is quantified by a perception score based on photographing month/date with the maximum value (score) in the vertical axis being set as 1.0. Such perception quantities vary depending on locations, so that a time perception range should be defined and set for each location. According to a year division system to divide a year into twenty-four seasons, for example, three time periods of early spring, mid spring and late spring, are provided for spring, so that it is possible to define three time perception areas (ranges) corresponding to such three time periods. Table 1 below shows certain examples of relationship between time perception terms and time perception scores, which form time perception data, in the case of time perception terms “spring level (degree)” and “mid spring level (degree)”.

TABLE 1

| Time Perception | |
|---|---|
| Term Indicating Season | Time Perception Score |
| Spring level (score from 0.0 to 1.0) | 0.831425598335068 |
| Mid spring level (score from 0.0 to 1.0) | 0.442906574394464 |

Next, the location perception data will be described. The location perception terms (language) are those based on which a user recognizes locations. Examples of the location perception terms (language) are those which are based on administrative divisions such as prefectures in Japan. It is possible to create e.g. a correspondence table between names of prefectures according to the administrative divisions and GPS values on the basis of the map mesh published by Geographical Survey Institute (Japan). It is also possible that “fuzziness of location” e.g. due to a natural landscape area and a vicinity of a central location such as a railway station is calculated as a perception score. In the case of the location perception data, boundary (threshold) values 0.0 and 1.0 of location perception scores can be set for boundary (threshold) levels, and other in-between levels of location perception can be quantified by a location perception function to calculate location perception quantities (values) between values 0.0 and 1.0 in a similar manner as in the case of the time perception data described above.

Next, the photographing condition perception data will be described. The photographing condition perception terms (language) to be used are those which are usually used corresponding to photographing conditions such as lens focal length, shutter speed, lens stop and sensitivity. For example, photographing condition perception terms such as “long” and “short” are used for the lens focal length, and those such as “fast” and “slow” for the shutter speed, while those such as “open” and “close” are used for the lens stop, and those such as “high” and “low” for the sensitivity. In the case of the photographing condition perception data, boundary (threshold) values 0.0 and 1.0 of photographing condition perception scores can be set for boundary (threshold) levels, and other in-between levels of photographing condition perception can be quantified by a photographing perception function to calculate location perception quantities (values) between values 0.0 and 1.0 in a similar manner as in the case of the time perception data described above.

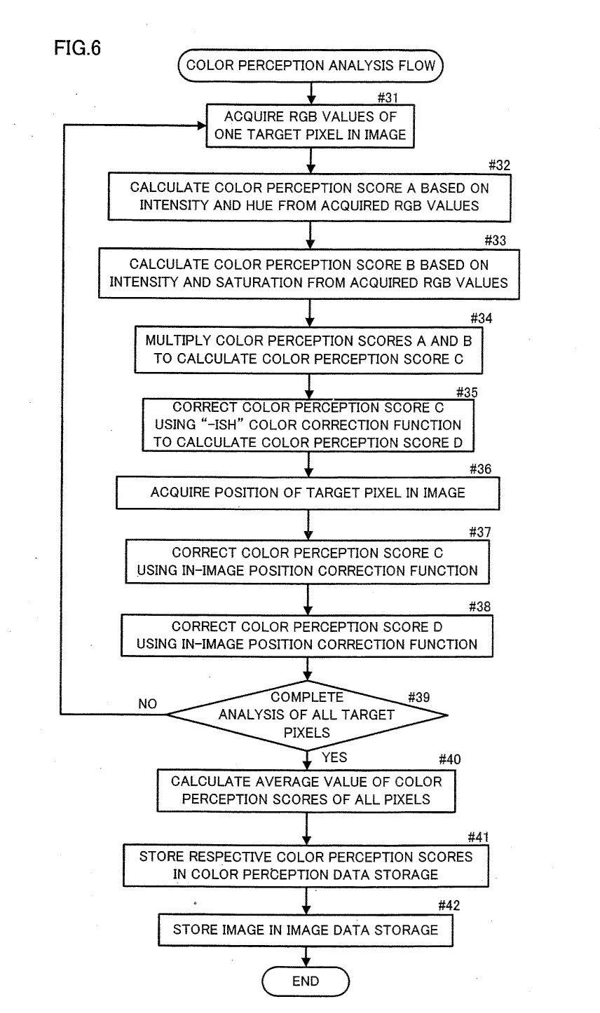

Next, the function of the color analysis processor 10 will be described. FIG. 6 is a detailed flow chart of the color perception analysis step (#5). In this step, the color analysis processor 10, which performs processing based on a color analysis program, reads pixel information of an image input from the image input unit 3, and converts RGB (Red, Green and Blue) values of pixels to HSI (Hue, Saturation and Intensity) values for analysis so as to calculate color (hue/saturation/intensity) perception data based on the HSI values and store the color perception data in the color perception data storage 15 (#31 to #42). That is, the color analysis processor 10 analyzes physical RGB quantities (values) to obtain color perception data, and stores the color perception data in the color perception data storage 15. Each color perception data is composed of a color perception term (language) and a color perception score.

The color perception terms (language) to be used are those which are generally used to express or describe colors such as red, blue and green. Japan Industrial Standard (JIS) Z8102 introduces many color perception terms based on systematic color names which express or describe colors by ten chromatic basic colors such as red, blue and green and achromatic colors such as black and white, accompanied by attributes of intensity (brightness) and saturation (chroma) such as bright, strong and dull (dim). This Standard also describes 269 kinds of traditional colors that cannot be handled systematically, such as bearberry (rose pink) color and cherry blossom color, which, however, are not associated with RGB. In complete contrast to physical RGB quantities (values) of a camera output image, it is known that color perception quantities (values) can be described by three attributes: Hue (H), Saturation (S) and Intensity (I). The above-described JISZ8102 is according to the Munsell Renotation Color System which is based on the HSI attributes.

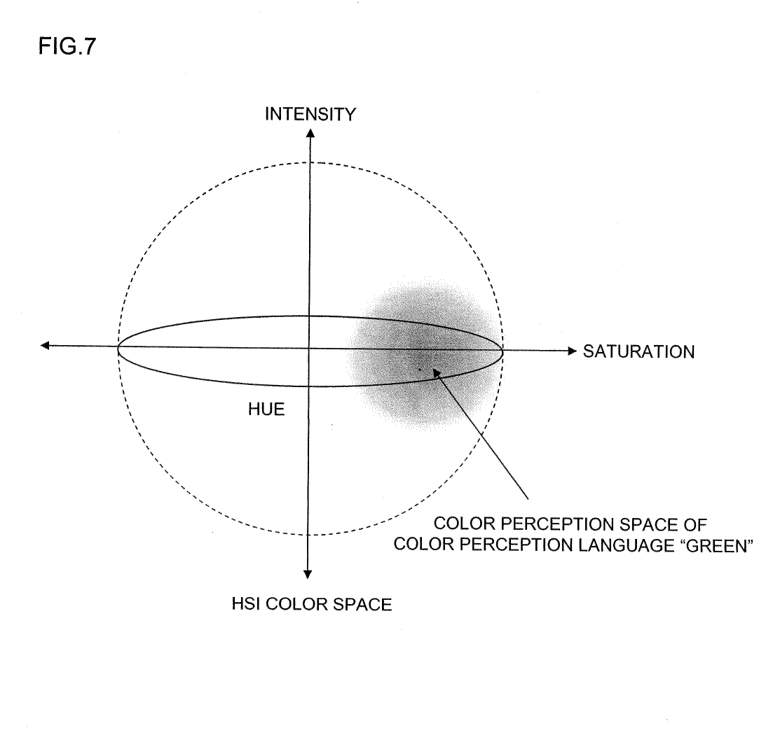

FIG. 7 is a schematic view of color perception space showing color perception quantity (value) in a three-dimensional HSI color space defined by the three attributes of hue, saturation and intensity, which is to be used for the color perception analysis step (#5). A boundary line between adjacent color spaces is defined for a color system, but is ambiguous or fuzzy. Furthermore, for traditional colors, representative colors are provided therefor, but boundaries of color spaces are not defined. In other words, color perception terms (language) have no definitions of respective areas (ranges) and levels (degrees), and are not quantified. Thus, in the present embodiment, the color analysis processor 10 first converts physical RGB quantities (values) to HSI quantities (values). Several proposals have been made for the conversion (e.g. digital image processing, CG-Art Association of Japan), but any of them can be used.

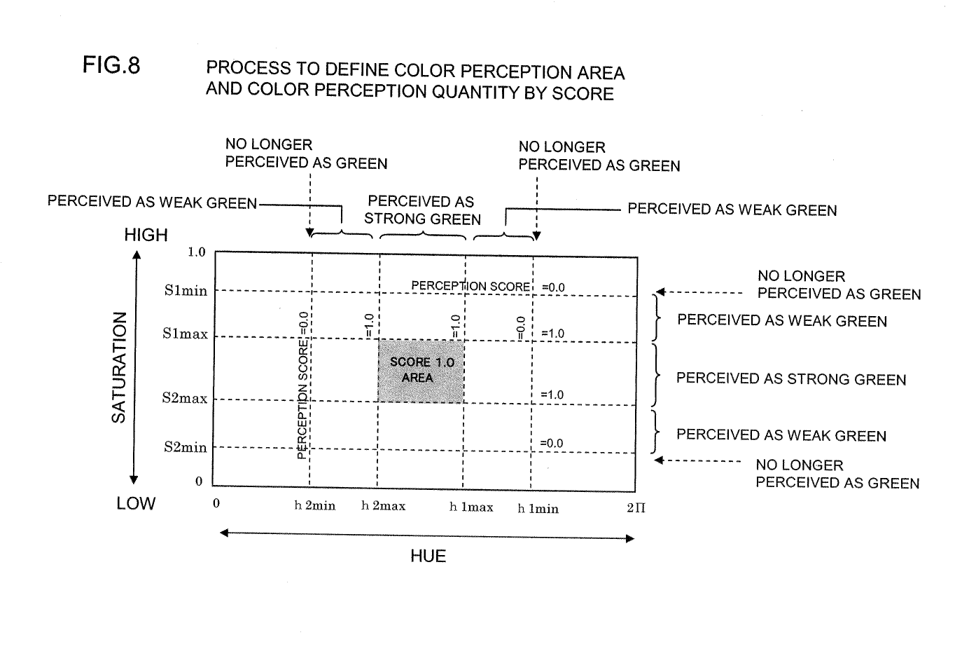

As described above, the color perception space is a three-dimensional space. For convenience, the intensity is divided into ten levels, and the color perception space is cut and divided by horizontal planes according to the levels of the intensity into ten cross-sections. Each of the cross-sections is defined by vertical and horizontal axes of hue and saturation. First, a method for quantifying areas (ranges) and levels (degrees) of respective colors in one two-dimensional plane with a fixed intensity will be described. FIG. 8 is a schematic chart of a portion of a two-dimensional plane of saturation and hue in a cross-section of the color perception space cut by a horizontal plane of intensity level 5 for color perception analysis. This chart shows a method for quantifying, by a score, a color perception area and a color perception quantity (value) to describe a color perception quantity associated with a color perception term “green”.

In order to quantify the level (degree) of color perception (hue perception) of green by a score, it is necessary to determine maximum boundary (threshold) values h2ₘₐₓ and h1ₘₐₓ of hue which allow the color to be perceived as strong green as well as minimum boundary (threshold) values h2ₘᵢₙ and h1ₘᵢₙ of hue which allow the color to be no longer perceived as green. Similarly, for saturation perception, it is necessary to determine maximum boundary (threshold) values S2ₘₐₓ and S1ₘₐₓ of saturation which allow the color to be perceived as strong green as well as minimum boundary (threshold) values S2ₘᵢₙ and S1ₘᵢₙ of saturation which allow the color to be no longer perceived as green. Table 2 below shows maximum boundary values h2ₘₐₓ, h1ₘₐₓ and minimum boundary values h2ₘᵢₙ, h1ₘᵢₙ of hue as well as maximum boundary values S2ₘₐₓ, S1ₘₐₓ and minimum boundary values S2ₘᵢₙ, S1ₘᵢₙ of saturation each under intensity 5. Boundary lines of color areas (ranges) have not been defined so far, and human ways of perceiving a color vary depending on the position of the colors in a color area. Under such situation, the values listed in Table 2 are those measured and determined using visual color measurement by the human eye to observe colors e.g. on a calibrated monitor under constant conditions so as to determine maximum and minimum boundary values of a color that determine a color area of the color.

TABLE 2

| Inten- | I | | | | | | | | |
|---|---|---|---|---|---|---|---|---|---|
| sity | (Inten- | | | | | | | | |
| level | sity) | h2ₘᵢₙ | h2ₘₐₓ | h1ₘₐₓ | h1ₘᵢₙ | S2ₘᵢₙ | S2ₘₐₓ | S1ₘₐₓ | S1ₘᵢₙ |
| 0 | 0.0 | — | — | — | — | — | — | — | — |
| 1 | 0.1 | — | — | — | — | — | — | — | — |
| 2 | 0.2 | 2.99 | 2.20 | 2.09 | 1.09 | 0.20 | 1.25 | 1.25 | 1.25 |
| 3 | 0.3 | 2.99 | 2.36 | 1.87 | 1.09 | 0.14 | 0.55 | 0.55 | 0.55 |
| 4 | 0.4 | 2.99 | 2.20 | 2.20 | 1.10 | 0.15 | 0.90 | 0.90 | 0.90 |
| 5 | 0.5 | 2.98 | 2.09 | 2.09 | 1.10 | 0.20 | 0.90 | 0.90 | 0.90 |
| 6 | 0.6 | 2.83 | 2.04 | 2.04 | 1.10 | 0.20 | 0.95 | 0.95 | 0.95 |
| 7 | 0.7 | 2.83 | 2.51 | 2.20 | 1.25 | 0.20 | 0.90 | 0.90 | 1.50 |
| 8 | 0.8 | 2.83 | 2.51 | 2.20 | 1.25 | 0.20 | 0.90 | 0.90 | 1.50 |
| 9 | 0.9 | 2.83 | 2.20 | 2.04 | 1.25 | 0.20 | 0.75 | 0.75 | 0.75 |
| 10 | 1.0 | 2.83 | 2.20 | 1.88 | 1.25 | 0.15 | 0.75 | 0.75 | 0.75 |

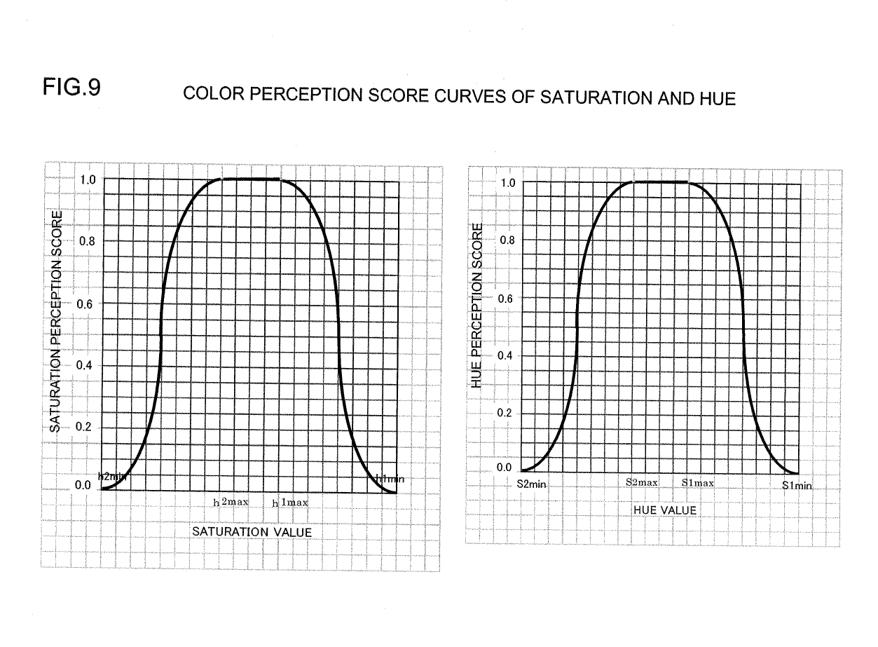

Table 2 shows specific values of pairs of minimum and maximum boundary values h2ₘᵢₙ, h2ₘₐₓ, h1ₘₐₓ, h2ₘᵢₙ, S2ₘᵢₙ, S2ₘₐₓ, S1ₘₐₓ, S1ₘᵢₙ. In order to obtain (measure) relative values (perception scores) of each color between the minimum and maximum boundary values, the color perception functions (color perception score curves of saturation and hue) shown in FIG. 9 are used to normalize the values. In the case of hue, for example, the normalization is done by converting, to value 1.0, the values of h1ₘₐₓ, h2ₘₐₓ which allow the color to be perceived as strong green, while converting, to value 0.0, the values of h1ₘᵢₙ, h2ₘᵢₙ which allow the color to be no longer perceived as green. Note that the dashes in Table 2 indicate that the intensity is too low (black out) to measure hue and saturation.

In this embodiment, the following “conversion equations using HSI hexagonal cone color model” based on the Oswald Color System are used to convert the RGB values to the HSI (hue, saturation and intensity) values:

π(pi): circumference ratio (3.1415. . . )
max=MAX(R,G,B): maximum value of R, G and B values
mid=MID(R,G,B): middle value of R, G and B values
min=MIN(R,G,B): minimum value of R, G and B values
H range: 0.0 to 2π, S range: 0.0 to 1.0, I range: 0.0 to 1.0
Different equations are used to calculate H depending on R, G and B values:
When R>G>B; H=(mid−min)/(max−min)*π/3
When G>R>B; H=−(mid−min)/(max−min)*π/3+(2π/3)
When G>B>R; H=(mid−min)/(max−min)*π/3+(2π/3)
When B>G>R; H=−(mid−min)/(max−min)*π/3+(4π/3)
When B>R>G; H=(mid−min)/(max−min)*π/3+(4π/3)
When R>B>G; H=−(mid−min)/(max−min)*π/3+(6π/3)
S is calculated using; S=max−min/max
I is calculated using; I=max/255

Using quadratic functions (curves) each with a constant (C), color perception scores of saturation and hue are calculated from the calculated HSI values. Note that the accuracy of the respective color perception scores varies depending on the constants, namely on how the constants are set. Further note that a pair of such curves is present at each intensity level, or more specifically that each of the eleven horizontal planes of intensity levels 0 to 10, respectively, has a pair of color perception score curves of saturation and hue. FIG. 9 is a graph of color perception score curves of saturation (on the left: saturation perception score vs. saturation value) and hue (on the right: hue perception score vs. hue value), each at an intensity N. From the color perception score curves shown in FIG. 9, a saturation perception score PNh and a hue perception score PNs at an intensity N are calculated. A color perception score is expressed by a product of a saturation perception score and a hue perception score, so that the color perception score at an intensity N is (PNh×PNs).

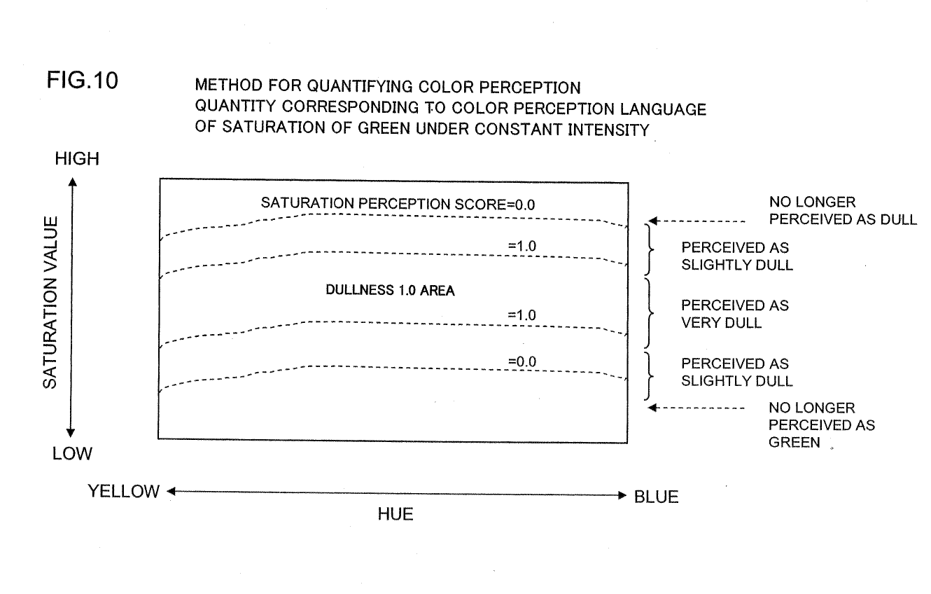

FIG. 10 is a chart showing a method for quantifying color perception quantity (value) corresponding to a color perception term of saturation of green under a constant intensity. Examples of color perception terms of saturation and intensity are “brilliant”, “bright”, “deep”, “dull”, “soft”, and so on. FIG. 10 shows a case where the perception term is “dull”. On a two-dimensional plane of saturation and hue in a cross-section of a perception space corresponding to perception terms of saturation and intensity, maximum and minimum boundary (threshold) values under a constant intensity are determined and set, using visual color measurement by the human eye, in a similar manner as in the perception space corresponding to a perception term of hue. Note, however, that in contrast to the perception terms of hue, the perception terms of saturation and intensity are based on perceptions common to any hue (all hues). Accordingly, the color perception quantity corresponding to the perception terms of saturation and intensity can span a wide color range under a constant or single intensity.

Color perception (perceptual) terms such as “brilliant”, “strong” and “dull”, which are mainly for saturation are present under the same intensity. Note, however, that, for example, the brilliance of “red” hue and the brilliance of “blue-green” hue are different from each other in psychological color perception quantity (value). Thus, each boundary line with a constant saturation perception score extends irregularly (nonlinearly) as shown in FIG. 10. On the other hand, perception terms such as “light” and “dark” are mainly for intensity, so that the color perception quantity corresponding to each such color perception term defines one narrow color range under the constant or single intensity.

Similarly as with the color perception terms of hue, the color perception terms of saturation and intensity define (determine) perception areas (ranges) on an arbitrary two-dimensional plane of saturation and hue at one of intensity levels which are equidistantly spaced from one another between the intensity levels 0 and 1.0. This makes it possible to define a color perception space and color perception scores corresponding to color perception terms of saturation and intensity, thereby quantifying color perception quantity in the color perception space. In addition, it is also possible to define a combined color perception space formed by combining color perception space corresponding to perception terms of hue with color perception space corresponding to color perception terms of saturation and intensity. For example, color perception spaces of “bright green”, “brilliant green” and so on can be defined.

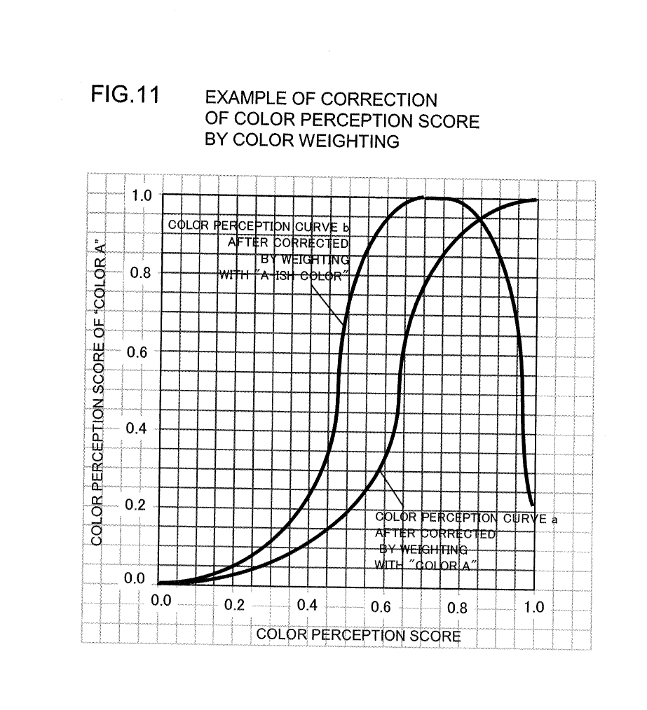

FIG. 11 is a graph of an example of correction of color perception score by color weighting, showing a method of converting the color perception score (obtained by the quantification described above) according to color perception language (terms), i.e. converting the color perception function in the case where a color perception term is modified to a compound term. More specifically, it is a color perception function to quantify a color perception quantity in a case such as “greenish color” where boundary values are present in a color perception area at a peripheral portion of each color (e.g. “green”), in contrast to a color perception area such as “green color” which has clearly recognizable boundary values at a central portion of each color (e.g. “green”) perception space.

Assuming that the “color perception curve a” represents “color A” (or “A-color”) as calculated or obtained for “color A”, it can be modified or corrected to the “color perception curve b” representing “A-ish color” by shifting the position of the maximum boundary value 1.0 determined by “color A” to a position around value 0.8 of “color A” as the position of the maximum boundary value 1.0 of “A-ish color” as shown in FIG. 11. This position shift to set the value 1.0 of “A-ish color” at a lower level causes an increase of values of the color area at a peripheral portion of the color so as to modify (convert) or correct the weighting of the color perception score of each pixel, thereby determining the “color perception curve b”. Not only in the case of “A-ish color”, but also in other colors such as “deep A-color” and “light A-color”, it becomes possible to describe a delicate color perception space by modifying or correcting the color perception function in a manner as described above.

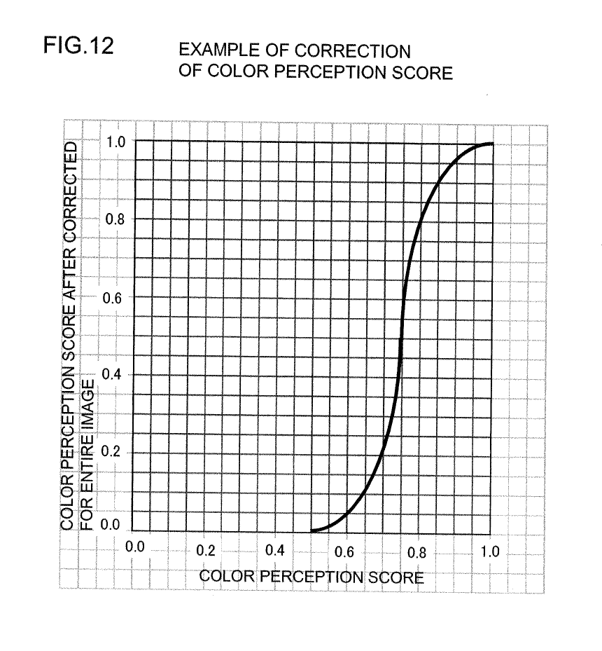

FIG. 12 is a graph of an example of correction of color perception score, showing a correction function to modify (convert) or correct the calculated or obtained color perception score of each pixel to a color perception score reflecting the consideration that the color perception score of each pixel contributes to, or influences, the color perception of the entire image. The use of this correction function allows that pixels with a color perception score lower than value 0.5 of a certain color are regarded as not contributing to the “color perception” of the entire image, thereby correcting the color perception score of the certain color of such pixels to zero. This correction function is an example. Other correction factors such as level or degree of integration, position in image plane, and so on can be treated similarly.

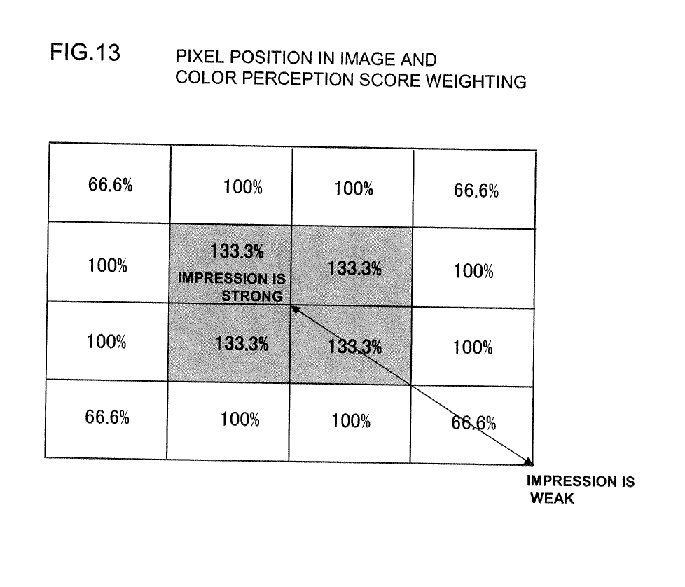

FIG. 13 is a chart of pixel position in image and color perception score weighting, showing a method for calculating a color perception score of a pixel according to a position of the pixel in image plane, or more specifically by additionally reflecting variation of color perception quantity according to a position of the pixel in image plane. Normally, an image is often photographed by positioning a target object at a central portion (position) of the image. This applies to the case of using e.g. a digital camera for the photographing. For example, in the case of a “red flower” photographed at a central portion of an image on a background of “green leaves” at a peripheral portion of the image, often the entire image has a higher color perception score of “green” color than “red” color. However, when a human observer sees the image, it usually focuses on the “red flower” positioned at the central portion, so that the color perception quantity changes to increase the color perception quantity of “red” color. The influence which the position (of a pixel) of the target object in the image exerts on the color perception quantity can be coped with by varying the weightings to (pixels of) the central portion and peripheral portion of the image depending on the degree of influence.

By the use of the quantification as described above, the color perception score of each pixel can be calculated. The color perception score of one image is calculated as the sum of the pixels. For example, assuming that an image has X pixels in a row and Y pixels in a column, it has pixels of (X*Y) points. Assuming furthermore that each of the n pixels has a color perception score PAn of “color A”, the color perception score PAn of each pixel (n-th pixel) can be separately calculated so as to obtain total (X*Y) PA values. The color perception score of one image can be calculated as the average of these PA values by using the equation (PA1+PA2+ . . . PA(X*Y))/(X*Y). By calculating color perception scores of all (or a sufficient number of) color perception terms (language) such as “red”, “vermilion” and so on in a similar manner, the color perception score of one image can be calculated. Note that when an image is seen as one image rather than the sum of pixels, the color perception score (color perception function) is varied or modified depending on the quantity of analogous colors, integration (degree of integration) of analogous colors, position in image plane, and so on.

As described in the foregoing, the image storage apparatus 101 of the present embodiment has a unique structure including the photograph information analysis processor 9 and the color analysis processor 10 of the central processing unit 5 to allow quantification of physical information about images received from the image input unit 3 by defining and quantifying, using scores, usually used perception terms (language) and corresponding perception quantities of time, location, photographing condition and color. The photograph information perception data and the color perception data, as the results of the photograph information analysis processor 9 and the color analysis processor 10, are stored in the photograph information perception data storage 14 and the color perception data storage 15, respectively, in the storage unit 6 of the image storage apparatus 101. The image content language data input from the image content language input unit 2 and the image data input from the image input unit 3 are stored in the image content language data storage 13 and the image data storage 16, respectively, in the storage unit 6 of the image storage apparatus 101.

(Description of Function of Image Retrieval Apparatus)

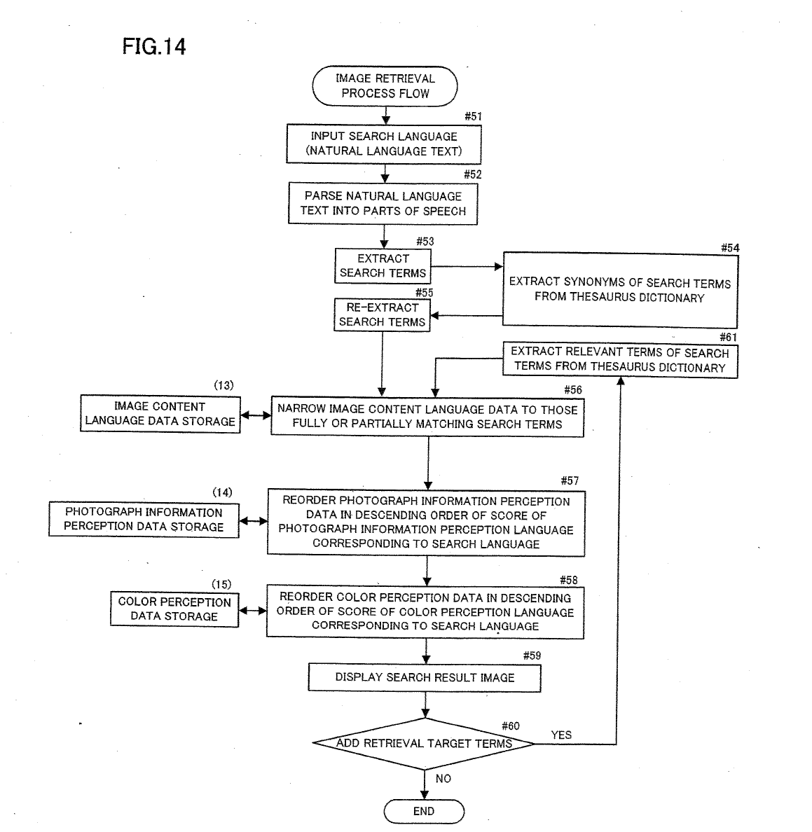

Referring now to FIGS. 14, 15 and 16, the function of the image retrieval apparatus 102 will be described below. Based on a natural language (text, sentence or search terms) input by a user, the image retrieval apparatus 102 retrieves an image from image data stored in the storage unit 6 of the image storage apparatus 101. FIG. 14 is a flow chart of an image retrieval process of the image retrieval apparatus 102. First, a user inputs a natural language text to identify or retrieve an image, using the search language input unit 22 (#51). The natural language text is a combination of terms composed of attributes and compounds. The input natural language text is parsed by the morphological analysis processor 29 of the central processing unit 25 into classified parts of speech (#52) so as to extract search terms (#53), which are then read and stored in the storage unit 24. From the thesaurus dictionary 27 stored in the storage unit 24, the synonym extraction processor 33 retrieves relevant data, such as “pronunciations”, “synonyms” and the like, of the search terms read and stored in the storage unit 24 (#54), and adds the relevant data to the data of the search terms (#55).

Thereafter, with reference to the image content language data in the image content language data storage 13 of the image storage apparatus 101, the image content language data narrowing processor 30 of the central processing unit 25 narrows down and extracts image content language data which fully or partially match the search terms read and stored in the storage unit 24 (#56). By the steps up to this point, images (image data) as the search result (such images being hereafter referred to as “retrieval target images”, which can also be referred to as retrieval candidate images) are extracted. Next starts a process of determining the display order of the retrieval target images. With reference to the photograph information perception data in the photograph information perception data storage 14 as well as the color perception data in the color perception data storage 15 of the image storage apparatus 101, the image perception data reordering processor 31 reorders photograph information perception data and color perception data in descending order of scores of photograph information perception language (terms) and color perception language (terms) corresponding to the search language (terms), respectively (#57, #58) (i.e. descending order of priority from highest priority to lowest), so as to display the retrieval target images in the reordered sequence or order (#59). The remaining steps #60, #61 of the flow chart of FIG. 14 will be described later.

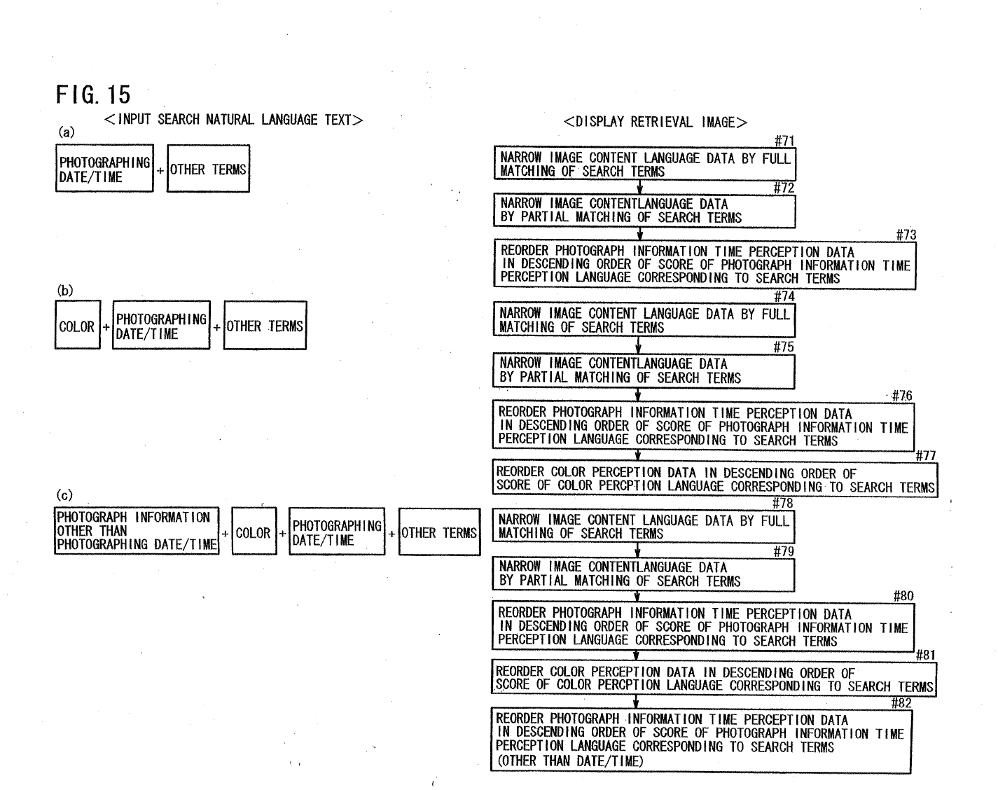

FIG. 15 is a chart showing processes of displaying retrieval images for three kinds of natural language texts (a), (b) and (c) input from the search language input unit 22. These processes corresponding to the three kids includes steps #71 to #73, steps #74 to #77, and steps #78 to #82, respectively, as will be apparent from the following description. The photograph information perception data corresponding to the retrieval target images are stored in the photograph information perception data storage 14 of the image storage apparatus 101. The image perception data reordering processor 31 reorders the photograph information perception data attributed to the retrieval target images in descending order of perception scores of perception terms corresponding to the search terms read and stored in the storage unit 24 (i.e. descending order of priority from highest priority to lowest). If the search terms include those that describe “color”, the color perception data is also reordered in a similar manner as in the photograph information perception data.

For example, if a natural language text “greenish pond in a spring afternoon around Nara” is input from the search language input unit 22, the morphological analysis processor 29 parses the input natural language text into “greenish”, “pond”, “spring”., “afternoon”, and “around Nara” as parts of speech so as to extract them as search terms and to read and store the search terms in the storage unit 24. From the thesaurus dictionary 27, the synonym extraction processor 33 extracts synonyms of the search terms read and stored in the storage unit 24, and add the synonyms in the data of the search terms. For example, if terms such as “near” and “neighborhood” are extracted from the thesaurus dictionary 27 as synonyms of “around”, these terms are added as additional search terms.

The image content language data narrowing processor 30 searches and determines whether the image content language data storage of the image storage apparatus 101 contains perception language data which fully or partially match the respective ones of the search terms so as to narrow down the retrieval target images. Among photographing condition perception data attributed to the retrieval target images having been thus narrowed down, those corresponding to the terms “near Nara”, “spring” and “afternoon” are reordered by the image perception data reordering processor 31 in descending order of perception scores corresponding to those terms (i.e. descending order of priority from highest priority to lowest). Similarly, among color perception data attributed to the retrieval target images, those corresponding to the term “greenish” are reordered by the image perception data reordering processor 31 in descending order of perception scores corresponding to such term. After completion of the reordering by the scores of the photograph information perception data and the color perception, the image data output processor 32 of the image retrieval apparatus 102 extracts and reads image data in the reordered sequence from the image data storage 16 of the image storage apparatus 101, and displays such image data on the image data output unit 23 of the image retrieval apparatus 102.

Depending on the search results, it is possible to further broaden the range of retrieval target images by adding relevant terms as retrieval targets to the search terms. In order to add search terms as retrieval targets to those already present by step #59 in the flow chart of FIG. 14, relevant terms are extracted from the thesaurus dictionary 27 (#60, #61). More specifically, the relevant term extraction processor 34 of the image retrieval apparatus 102 retrieves and extracts, from the thesaurus dictionary 27, relevant terms including broader terms and narrower terms of the search terms read and stored in the storage unit 24. For this to be possible, it is necessary for the thesaurus dictionary 27 to be a database having a hierarchy of managed relationships between terms.

For example, assuming “flower” as a primary search term, a user may not think of narrower terms such as “cherry blossom”, “rose” and “sunflower”. Yet, it is possible to include, in retrieval targets, image data corresponding to such terms by allowing the relevant term extraction processor 34 to acquire search terms from the thesaurus dictionary 27 containing relevant terms including broader and narrower terms, which correspond to the primary search term (“flower”), thereby making it possible to broaden the range of retrieval targets based on relevant concepts. Thus, it is possible to include, in retrieval targets, not only image data provided with an image content term “flower”, but image data provided with relevant terms of “flower” such as “cherry blossom”, “rose” and “sunflower”.

As apparent from the above description, the image storage apparatus 101 of the present embodiment allows input of not only image content language (terms) but also physical quantities such as color and photograph information obtained from images so as to automatically extract, quantify and store perception language or terms (for photograph information perception and color perception) to describe color, time, location, photographing condition and so on. On the other hand, the image retrieval apparatus 102 of the present embodiment allows input of a natural language text (sentence) including perception terms as search keys to narrow retrieval target images based on image content language (terms) stored in the image storage apparatus 101, and to extract images corresponding to high priority (high perception scores) of the perception language (terms). This makes it possible to quickly retrieve images meeting perceptual requirements of a user with high accuracy.

It is possible to design the image storage/retrieval system 100 of the present embodiment to display image content language (terms) stored in the image storage 101 in association with the language (term) system of the thesaurus dictionary 27 stored in the image retrieval apparatus 102 so as to help a user to find an appropriate natural language for search and retrieval of images. This makes it possible to display image-describing language (term) information for each category of the language (terms) (on a category-by-category basis). This allows the user to reference the language information to consider search terms, thereby helping the user to input an appropriate language (term or terms) meeting its perceptual requirements.

It is also possible to classify the image content language data stored in the image storage apparatus 101 according to the language system of the thesaurus dictionary 27 associated with the synonym extraction processor 33 and the relevant extraction processor 34 so as to help the user to use the search language input unit 22. Similarly, it is possible to design so that the image content terms (language) associated with image data are classified according to the synonyms or relevant terms including broader and narrower terms of the thesaurus dictionary 27, so as to display the image content language (terms) to facilitate the user to use the search language input unit 22. Thereby, the user can recognize the volume of image content language (terms) associated with the image data for each class or category of the thesaurus, facilitating the user to select search terms.

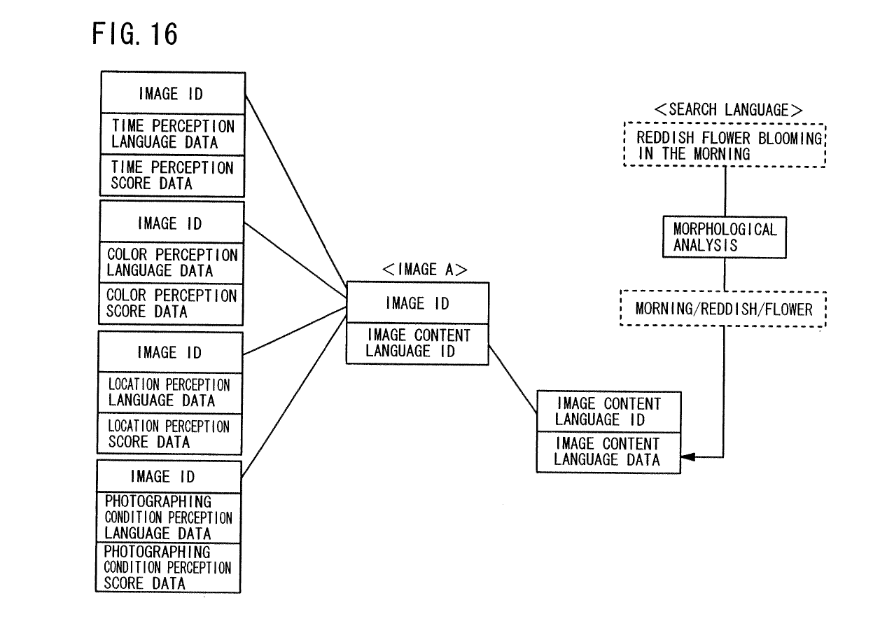

Referring to Tables 3a to 3d and FIG. 16, an example of image storage and image retrieval will be described, where a search language (text) “reddish flower blooming in the morning” is used as an example. Table 3a shows an image ID (identifier) and a tag ID for each of images, and Table 3b shows an example of image content language data for each of the images, while Table 3c shows an example of set of time perception scores of time perception language for each of the images, and Table 3d shows an example of set of color perception scores of color perception language for each of the images. On the other hand, FIG. 16 is a relationship chart used to search and retrieve an image(s) using search language as a search key. As shown in FIG. 16, image content language data is selected based on search language, and then an image ID (or IDs) is extracted using an image content language ID (or IDs) provided (attached) to the image content language data as an index so as to extract an image (or images). Referring to these Tables and FIG. 16, with the example of search language “reddish flower blooming in the morning”, the image A which contains “flower” in the image content language data is retrieved (hit), and then the images B and C are also analyzed as retrieval target images on the basis of the perception scores of “morning” and “red”, although the images B and C are given lower priorities than that of the image A.

TABLE 3a

| | Image ID | Image Content Language ID |
|---|---|---|
| Image A | 1000 | 2000 |
| Image B | 1001 | 2001 |
| Image C | 1002 | 2002 |
| . | . | . |
| . | . | . |
| . | . | . |

TABLE 3b

| | Image ID | Image Content Language |
|---|---|---|
| Image A | 1000 | red spring flower |
| Image B | 1001 | skinny dog and roses adorning gate |
| Image C | 1002 | first star of evening |
| . | . | . |
| . | . | . |
| . | . | . |

TABLE 3c

| | | “Morning” | | |
|---|---|---|---|---|
| | Image ID | Score | “Afternoon” Score | “Night” Score |
| Image A | 1000 | 0.801 | 0.002 | 0 |
| Image B | 1001 | 0.150 | 0.782 | 0.001 |
| Image C | 1002 | 0 | 0.004 | 0.835 |
| . | . | . | . | . |
| . | . | . | . | . |
| . | . | . | . | . |

TABLE 3d

| | Image ID | “Red” Score | “Reddish” Score | “Green” Score |
|---|---|---|---|---|
| Image A | 1000 | 0.911 | 0.030 | 0.002 |
| Image B | 1001 | 0.689 | 0.850 | 0.103 |
| Image C | 1002 | 0 | 0.560 | 0.235 |
| . | . | . | . | . |
| . | . | . | . | . |
| . | . | . | . | . |

(Image Storage/Retrieval and Communication Systems)

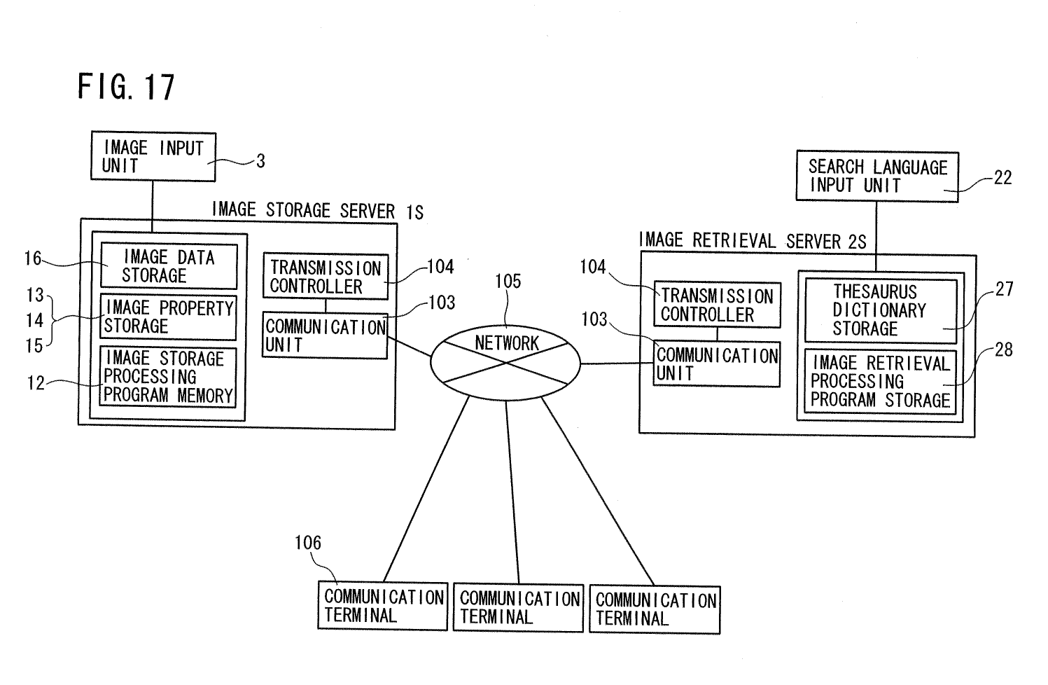

FIG. 17 is a schematic block diagram of a network structure of an image storage/retrieval system according to an embodiment of the present invention. Referring to FIG. 17, an image storage server IS and an image retrieval server 2S are equivalent to the image storage apparatus 101 and the image retrieval apparatus 102, respectively, each having a communication unit 103 and a transmission controller 104, so as to be remotely connected to each other via a network 105. Multiple communication terminals 106 having functions similar to those of the servers IS, 2S are connected to the network 105. This structure makes it possible to remotely retrieve images from image database located at a remote place via a communication line by using perception language. An example of a specific example of the image storage/retrieval system 100 (image storage apparatus 101 and image retrieval apparatus 102) will be described below.

### SPECIFIC EXAMPLE

The equipment used were two computers having WindowsXP (registered trademark) installed therein, a CPU (Central Processing Unit) of Intel Xeon Processor of 64 bit (2.80 GHz), a memory (1 GB), a monitor (TFT: liquid crystal display monitor) of 20 inches, a hard disk of 250 GB for image storage, a hard disk of 160 GB for image retrieval, and a digital camera (single-lens reflex camera of Nikon D2X) for photographing. Using the digital camera, a luxuriant tree against a background of natural landscape was photographed as an image so as to position the tree at a central portion of the image. The image size was 2000×3008 pixels, and the photographing data/time was 14:30 (2:30 PM) of May 5, while the weather was good when the photograph was taken. After photographing, the digital camera was connected via USB (Universal Serial Bus) to an image storage apparatus 101 so as to allow the image storage apparatus 101 to read and store the photographed image. (It is also possible to remotely upload data of the image to a shared site.)

The photographed image was input from the image input unit 3, and then an image storage processing program stored in the image storage apparatus 101 was activated. The image storage processing program is composed of a morphological analysis program, a photograph information analysis program and a color analysis program. First, the morphological analysis program was activated. Using a combination of a keyboard and a mouse as an image content language input unit 2, information (language) of the image was input. A title “A Large Rose” was given to the photographed image. This character string information (text), as a language (text or term) data, was processed by the morphological analysis processor 8 of the central processing unit 5 of the image storage apparatus 101 so as to be stored in the image content language data storage 13 in the storage unit 6 of the image storage apparatus 101. At this time, a unique number was assigned to the language data so as to make it distinguishable from data of other images.

Next, a photograph information analysis program was activated, whereby the photograph information analysis processor 9 of the central processing unit 5 of the image storage apparatus 101 read and analyzed Exif (Exchangeable Image File Format) data of the input image. The Exif file has a header section and a data section divided from each other, in which the header section is simply a magic number, while the data section has photograph information such as photographing date/time written therein. In order to remove the header of the Exif file, it is sufficient to simply remove a portion of the file from byte 0 to byte 6. Here, the following method was used to this end:

% dd if=hoge.appl of =hage.tiff bs=skip=6

The photograph information analysis processor 9 extracted and analyzed photographing date/time information, photographing location information and photographing condition information from the data section of the Exif file. The Exif file has a head such as the following*

00000000: ffd8ffe1 28984578 69660000 49492a00| . . . (.Exif.II*

00000010: 08000000 0d000e01 02000700 0000aa00| . . .

The photograph information analysis processor 9 quantified, by scores, perception quantities of the analyzed photographing data/time information, photographing location information and photographing condition information, respectively, using the time perception functions (curves) corresponding to perception language, which are shown in FIG. 4 and FIG. 5. Table 4a and Table 4b below are correspondence tables between photographing date/time and time perception language (terms).

TABLE 4a

| | | May 5 |
|---|---|---|
| 1 | Spring | 0.826990 |
| 2 | Early Spring | — |
| 3 | Mid Spring | 0.800000 |
| 4 | Late Spring | 0.680000 |
| . | | |
| . | | |
| . | | |
| 22 | February (2: Kisaragi) | |
| 23 | March (3: Yayoi) | — |
| 24 | April (4: Uzuki) | — |
| 25 | May (5: Satsuki) | 1.000000 |
| 26 | June (6: Minazuki) | — |
| 27 | July (7: Fumizuki) | — |
| 28 | August (8: Hazuki) | — |
| . | | |
| . | | |
| . | | |
| 43 | Mid April | |
| 44 | Late April | — |
| 45 | Early May | 0.836735 |
| 46 | Mid May | 0.163265 |
| 47 | Late May | — |
| . | | |
| . | | |
| . | | |
| 69 | Equinoctial week | |
| 70 | “Golden Week” (late April through early May) | 1.000000 |
| 71 | [symbol] | — |
| . | | |
| . | | |
| . | | |
| 78 | National Foundation Day (February 11) | |
| 79 | Children's Day (May 5) | 1.000000 |
| 80 | Boys' Festival Day (May 5) | 1.000000 |
| 81 | Bon Festival (Mid August) | — |
| 82 | Tanabata (Star) Festival Day (July 7) | — |
| 83 | Choyo-no-sekku Festival Day (September 9) | — |
| . | | |
| . | | |
| . | | |

TABLE 4b

| | | 14:30 |
|---|---|---|
| 1 | AM | — |
| 2 | PM | 1.000000 |
| 3 | Morning | — |
| 4 | Early morning | — |
| 5 | Late morning | — |
| 6 | Afternoon | 1.000000 |
| 7 | Early afternoon | 0.098765 |
| 8 | Late afternoon | 0.098765 |
| 9 | Evening | — |
| 10 | Early evening | — |
| 11 | Late evening | — |
| 12 | Night | — |
| . | | |
| . | | |
| . | | |

In each of the Tables 4a and 4b, the middle column lists time perception language (terms), while the right column lists time perception scores in which the dashes “-” in the each table indicate value 0 (zero). The photographing data/time (information) was 14:30 (2:30 PM) of May 5, so that the perception scores indicating most of the levels of spring in terms of spring were high as shown in each table. More specifically, the perception score of spring was 0.826990, and the perception score of mid spring was 0.800000, while the perception score of late spring was 0.680000. However, the perception score of early spring was zero because it was May 5. Similarly the perception score of May (Satsuki) was 1.000000, and the perception score of early May was 0.836735, showing high perception scores therein in terms of month. In contrast, the perception score of mid May was 0.632651, and the perception score of late May was zero, indicating appropriate score quantification corresponding to May 5 which is in early May.

Furthermore, as shown in Table 4a, each perception score of “Golden Week”, Children's Day and Boys'Festival Day was 1.000000, also indicating appropriate score quantification corresponding to the week and holiday of May 5. As described above, the perception score data with the perception language as obtained by the photograph information analysis processor 9 were stored in the photograph information perception data storage 14 in the storage unit 6 of the image storage apparatus 101. In a similar manner, perception scores of the photographing location data and the photographing condition data were quantified by the photograph information analysis processor 9, which were then stored in the photograph information perception data storage 14.

Next, a color analysis program was activated, whereby the color analysis processor 10 of the central processing unit 5 of the image storage apparatus 101 the input image data on a pixel-by-pixel basis. More specifically, the color analysis program operates to acquire RGB values of each pixel starting from the upper-leftmost pixel rightward in the uppermost line, and then downward in the other lines sequentially, to the lower-rightmost pixel in the lowermost line of the image. Assuming that the coordinate of the starting point at the upper-leftmost pixel is (0,0), the results of the color analysis performed for the pixel at a coordinate of (300,−200) will be described below. Table 5 below is a color list, which is a list of color perception terms (language) usable or identifiable (recognizable) in the image storage/retrieval system 100 of the present embodiment.

TABLE 5

| | |
|---|---|
| 1 | Toki-iro |
| 2 | Tsutsuji-iro |
| 3 | Sakura-iro |
| 4 | Bara-iro |
| 5 | Karakurenai-iro |
| 6 | Sango-iro |
| 7 | Koubai-iro |
| 8 | Momo-iro |
| 9 | Beni-iro |
| 10 | Beniaka-iro |
| 11 | Enji-iro |
| 12 | Suou-iro |
| 13 | Akane-iro |
| 14 | Aka-iro |
| 15 | Shu-iro |
| 16 | Benikaba-iro |
| 17 | Benihi-iro |
| 18 | Entan-iro |
| 19 | Beniebicha-iro |
| 20 | Tobi-iro |
| 21 | Azuki-iro |
| 22 | Bengara-iro |
| 23 | Ebicha-iro |
| 24 | Kinaka-iro |
| 25 | Akacha-iro |
| 26 | Akasabi-iro |
| 27 | Ouni-iro |
| 28 | Akadaidai-iro |
| 29 | Kaki-iro |
| 30 | Nikkei-iro |
| 31 | Kaba-iro |
| 32 | Renga-iro |
| 33 | Sabi-iro |
| 34 | Hiwada-iro |
| 35 | Kuri-iro |
| 36 | Kiaka-iro |
| 37 | Taisha-iro |
| 38 | Rakuda-iro |
| 39 | Kicha-iro |
| 40 | Hada-iro |
| 41 | Daidai-iro |
| 42 | Haicha-iro |
| 43 | Cha-iro |
| 43 | Kogecha-iro |
| 45 | Kouji-iro |
| 46 | Anzu-iro |
| 47 | Mikan-iro |
| 48 | Kasshoku |
| 49 | Tsuchi-iro |
| 50 | Komugi-iro |
| 51 | Kohaku-iro |
| 52 | Kincha-iro |
| 53 | Tamago-iro |
| 54 | Yamabuki-iro |
| 55 | Oudo-iro |
| 56 | Kuchiba-iro |
| 57 | Himawari-iro |
| 58 | Ukon-iro |
| 59 | Suna-iro |
| . | |
| . | |
| . | |

As a precondition for the calculation of color perception scores, it is necessary to calculate and define color perception scores based on a hue function under a certain intensity with respect to all the colors listed in Table 5. The above described FIGS. 8 to 12 and Table 2 show a method of such calculation. Using such color perception function, the color analysis processor 10 of the central processing unit 5 of the image storage apparatus 101 calculated a color perception score of intensity and hue from the data of an analysis target pixel (R=18, G=108, B=84) read and stored from the input image. This analysis target pixel meets the case of G>B>R, so that the following equations are to be used with max=108, mid=84 and min=18:
H=(mid−min)/(max−min)*π/3+(2π/3)
S=max−min/max
I=max/255

Respective values thus calculated were H=2.862255554, S=0.833333333 and I=0.423529411. The intensity (I) of 0.423529411 indicates that the color perception of intensity is positioned between intensity level 4 and intensity level 5. Referring to Table 2 with H=2.862255554, S=0.833333333 and the intensity level between 4 and 5, it is determined that the target pixel is positioned in a color perception area between h2ₘᵢₙ and h2ₘₐₓ as well as between S2ₘᵢₙ and S2_{max.}

Next, a color perception score was calculated as below. Since I=0.423529411, between intensity levels 4 and 5, the color perception functions of saturation and hue required in this case are those each under intensity levels 4 and 5. Using the color perception functions of saturation and hue of “green”, color perception scores were calculated as follows:

For intensity level 4:

Color perception score of hue P4h=0.212521896

Color perception score of saturation P4s=1.814058956

Thus, color perception score of hue and saturation under intensity level 4 is:
P4h×P4s=0.385527248

For intensity level 5:

Color perception score of hue P5h=0.637427626

Color perception score of saturation P4s=1.147842054

Thus, color perception score of hue and saturation under intensity level 5 is:
P5h×P5s=0.731666235

Based on the color perceptions scores thus calculated in the two-dimensional plane of hue and saturation along with the intensity value I=0.423529411, the color perception score d in the three-dimensional color space was calculated as follows:

$$\begin{matrix}d = ( P ( N + 1 ) h ⨯ P ( N + 1 ) s ) ⨯ d 1 + ( PNh ⨯ PNs ) ⨯ d 2 \\ = ( 0.731666235 ) ⨯ ( 0.423529411 - 0.4 ) ⨯ 10 + \\ ( 0.385527248 ) ⨯ ( 0.5 - 0.423529411 ) ⨯ 10 \\ \dot{{=}_{.}} 0.4670\end{matrix}$$

Referring to FIG. 12, the thus calculated score 0.4670 is corrected (converted) to zero when subjected to the correction to reflect the color perception of the entire image, so that the resultant color perception score of “green” of this pixel was determined as zero score. Similarly, the thus calculated score 0.4670 was also determined as a color perception score of zero when subjected to the color weighting of “greenish” using the “-ish” function (curve) shown in FIG. 11. The calculation method described here was applied to all the colors or color perception terms listed in Table 5. Table 6 below shows a list of resultant color perception scores of the color perception terms in Table 5 as thus calculated.

TABLE 6

R = 18
G = 108
B = 84

| | | Color | |
|---|---|---|---|
| | | Perception | Location |
| | | Score | Conversion |
| 1 | Toki-iro | | |
| 2 | Tsutsuji-iro | | |
| 3 | Sakura-iro | | |
| 4 | Bara-iro | | |
| 5 | Karakurenai-iro | | |
| 6 | Sango-iro | | |
| 7 | Koubai-iro | | |
| 8 | Momo-iro | | |
| 9 | Beni-iro | | |
| 10 | Beniaka-iro | | |
| 11 | Enii-iro | | |
| . | | | |
| . | | | |
| . | | | |
| 77 | Matsuba-iro | | |
| 78 | Byakuroku-iro | | |
| 79 | Midori-iro | | |
| 80 | Tokiwa-iro | 0.896722 | 0.597815 |
| 81 | Rokushou-iro | | |
| 82 | Chitosemidori-iro | | |
| 83 | Fukamidori-iro | 0.813508 | 0.542339 |
| 84 | Moegi-ko | 0.806045 | 0.537363 |
| 85 | Wakatake-iro | | |
| 86 | Seiji-iro | | |
| 87 | Aotake-iro | | |
| 88 | [symbol] | | |
| . | | | |
| . | | | |
| . | | | |
| 214 | Apple green | | |
| 215 | Mint green | | |
| 216 | Green | | |
| 217 | Cobalt green | | |
| 218 | Emerald green | | |
| 219 | Malachite green | 0.868884 | 0.579256 |
| 220 | Bottle green | | |
| 221 | Forest green | 0.087777 | 0.058518 |
| 222 | Viridian | 0.874187 | 0.582791 |
| 223 | Billiard green | 0.016286 | 0.010857 |
| 224 | Peacock green | | |
| 225 | Nile blue | | |
| 226 | Peacock blue | | |
| 227 | Turquoise blue | | |
| 228 | Oil blue | | |
| . | | | |
| . | | | |
| . | | | |
| 270 | Reddish | | |
| 271 | Yellow reddish | | |
| 272 | Skinish | | |
| 273 | Brownish | | |
| 274 | Yellowish | | |
| 275 | Yellow greenish | | |
| 276 | Greenish | | |
| 277 | Blue greenish | | |
| 278 | Bluish | | |
| 279 | Blue purplish | | |
| 280 | Purplish | | |
| 281 | Red purplish | | |
| 282 | Whitish | | |
| 283 | Grayish | | |
| 284 | Blackish | | |

In Table 6, the middle column (“Color perception Score”) shows color perception scores of the analysis target pixel, while the right column (“Location conversion”) shows color perception scores obtained by subjecting those in the middle column to location conversion process (location-based correction) with respect to the location of the image. Table 6 shows that this pixel (analysis target) had color perception scores of “Tokiwa-iro” (green of evergreen trees), “Fukamidori-iro” (deep green), “Moegi-iro” (color halfway between blue and yellow or light yellow-green), malachite green, forest green, viridian and billiard green, but had no color perception scores of, or had zero score each of, all the fifteen “-ish” colors according to the “-ish” correction, that are “reddish”, “yellow reddish”, “skinish”, “brownish”, “yellowish”, “yellow greenish”, “greenish”, “blue greenish”, “bluish”, “blue purplish”, “purplish”, “red purplish”, “whitish”, “grayish” and “blackish”.

The thus calculated color perception scores were weighted based on the color perception score weighting shown in FIG. 13 according to the position of the pixel (analysis target) in the image. Since this pixel is positioned at (300,−200) on the assumption that the coordinate of the starting point at the upper-leftmost pixel is (0,0), the color perception score weighting according to the pixel position is 2/3 or 0.666 (66.6%) by definition. The color perception scores of the above described “Tokiwa-iro” (green of evergreen trees), “Fukamidori-iro” (deep green), “Moegi-iro” (color halfway between blue and yellow or light yellow-green), malachite green, forest green, viridian and billiard green were subjected to the location-based correction (location conversion process) by multiplying a correction factor of 2/3 (=0.66666666) for score correction conversion, whereby the following values (scores) were obtained by calculation:
[After Correction]=[Before Correction]×Correction Factor
0.591837=0.896722×2/3 (Tokiwa-iro)
0.542339=0.813508×2/3 (Fukamidori-iro)
0.537363=0.806045×2/3 (Moegi-iro)
0.579256=0.868884×2/3 (Malachite green)
0.058518=0.087777×2/3 (Forest green)
0.582791=0.874187×2/3 (Viridian)
0.010857=0.016286×2/3 (Billiard green)

Based on the calculations described above, color perception scores of one pixel (analysis target pixel) on the one image were calculated. The set of calculations were repeated for all the pixels in the image. After color perception scores of all the pixels were thus obtained by calculation, an average score of the color perception scores of all the pixels was obtained by:
[Average Score]=[Sum Scores of All Pixels]/[Number of Pixels]

The calculated color perception score data calculated by the color analysis processor 10 of the central processing unit 5 of the image storage apparatus 101 along with the color perception language data were stored in the color perception data storage 15 in the storage unit 6 of the image storage apparatus 101. The image data, whose image content language data, photograph information perception data and color perception data were stored in the respective storages in the storage unit 6 of the image storage apparatus 101, were processed by the image storage processor 11 of the image storage apparatus 101 so as to be stored in the image data storage 16 in the storage unit 6 as well.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

What is claimed is:

1. An image storage/retrieval system comprising an image storage apparatus and an image retrieval apparatus,
wherein the image storage apparatus comprises:
an image input unit for receiving a photographed image data and outputting an output signal of the image data;
an image content language input unit for inputting language data (hereafter referred to as “image content language data”) indicating content of an image;
an image content language data storage unit for storing the image content language data input by the image content language input unit;
a photograph information analysis unit for analyzing the output signal of the image input unit so as to output data (hereafter referred to as “photograph information perception data”) quantitatively associated with predetermined perception language relating to photograph information;
a photograph information perception data storage unit for storing the photograph information perception data;
a color perception analysis unit for analyzing the output signal of the image input unit so as to output data (hereafter referred to as “color perception data”) quantitatively associated with predetermined perception language relating to colors;
a color perception data storage unit for storing the color perception data; and
an image data storage unit for storing image data corresponding to the image content language data, the photograph information perception data and the color perception data, and
wherein the image retrieval apparatus comprises:
a search language input unit for inputting language (hereafter “search language”) for search and retrieval;
an image content language data narrowing unit coupled to the image storage apparatus for comparing the image content language data stored in the image content language data storage unit with the search language input from the search language input unit so as to extract image content language data at least partially matching the search language; and
an image data output unit for extracting and outputting images stored in the image data storage unit in descending order of priority of perception language corresponding to the search language with reference to the photograph information perception data and the color perception data attributed to retrieval target images and including the image content language data narrowed by the image content language data narrowing unit.

2. The image storage/retrieval system according to claim 1, wherein the image retrieval apparatus further comprises a morphological analysis unit for parsing the language input from the search language input unit into, and outputting, terms as search keys, and wherein:
the image content language narrowing unit compares the image content language data with the search keys output by the morphological analysis unit so as to narrow retrieval target data and output narrowed retrieval target data; and
the image data output unit comprises an image perception data reordering unit for reordering the output narrowed retrieval target data for each image perception data corresponding to the search language so as to display the images according to result of the reordering.

3. The image storage/retrieval system according to claim 2, wherein the image retrieval apparatus further comprises a synonym extraction processor and/or a relevant term extraction processor for extracting, from a thesaurus dictionary, information of synonyms of the search keys and/or relevant terms of the search keys output by the morphological analysis unit, and for adding the extracted information as the search keys.

4. The image storage/retrieval system according to claim 1, wherein:
the photograph information analysis unit analyzes the output signal of the image input unit so as to output photograph information perception data including photograph information perception language data and a photograph information perception score; and
the color perception analysis unit analyzes the output signal of the image input unit so as to output color perception data including color perception language data and a color perception score.

5. The image storage/retrieval system according to claim 4, wherein the image retrieval apparatus further comprises a morphological analysis unit for parsing the language input from the search language input unit into, and outputting, terms as search keys, and wherein:
the image content language narrowing unit compares the image content language data with the search keys output by the morphological analysis unit so as to narrow retrieval target data and output narrowed retrieval target data; and
the image data output unit comprises an image perception data reordering unit for reordering the output narrowed retrieval target data for each image perception data corresponding to the search language so as to display the images according to result of the reordering.

6. The image storage/retrieval system according to claim 5, wherein the image retrieval apparatus further comprises a synonym extraction processor and/or a relevant term extraction processor for extracting, from a thesaurus dictionary, information of synonyms of the search keys and/or relevant terms of the search keys output by the morphological analysis unit, and for adding the extracted information as the search keys.

7. The image storage/retrieval system according to claim 1, wherein the color perception analysis unit has a color perception function to calculate a color perception score corresponding to each color perception language, and allows the color perception function to be modified for adaptation to a color corresponding to compound color perception language in a same color perception space.

8. The image storage/retrieval system according to claim 7, wherein the image retrieval apparatus further comprises a morphological analysis unit for parsing the language input from the search language input unit into, and outputting, terms as search keys, and wherein:
the image content language narrowing unit compares the image content language data with the search keys output by the morphological analysis unit so as to narrow retrieval target data and output narrowed retrieval target data; and
the image data output unit comprises an image perception data reordering unit for reordering the output narrowed retrieval target data for each image perception data corresponding to the search language so as to display the images according to result of the reordering.

9. The image storage/retrieval system according to claim 8, wherein the image retrieval apparatus further comprises a synonym extraction processor and/or a relevant term extraction processor for extracting, from a thesaurus dictionary, information of synonyms of the search keys and/or relevant terms of the search keys output by the morphological analysis unit, and for adding the extracted information as the search keys.

10. The image storage/retrieval system according to claim 7, wherein the color perception analysis unit modifies the color perception function depending on quantity and degree of integration of colors contained in image and on position in image plane.

11. The image storage/retrieval system according to claim 10, wherein the image retrieval apparatus further comprises a morphological analysis unit for parsing the language input from the search language input unit into, and outputting, terms as search keys, and wherein:
the image content language narrowing unit compares the image content language data with the search keys output by the morphological analysis unit so as to narrow retrieval target data and output narrowed retrieval target data; and
the image data output unit comprises an image perception data reordering unit for reordering the output narrowed retrieval target data for each image perception data corresponding to the search language so as to display the images according to result of the reordering.

12. The image storage/retrieval system according to claim 11, wherein the image retrieval apparatus further comprises a synonym extraction processor and/or a relevant term extraction processor for extracting, from a thesaurus dictionary, information of synonyms of the search keys and/or relevant terms of the search keys output by the morphological analysis unit, and for adding the extracted information as the search keys.

13. An image storage apparatus to be used in the image storage/retrieval system according to claim 1.

14. An image retrieval apparatus to be used in the image storage/retrieval system according to of claim 1.

15. An image storage/retrieval program for an image storage/retrieval system comprising an image storage apparatus and an image retrieval apparatus each having a computer,
wherein the image storage/retrieval program allows the image storage apparatus to execute:
an image input step for inputting a photographed image data to an image input unit;
a data storing step for storing image content language data indicating content of an image input from an image content language input unit in an image content language data storage unit;
a photograph information analyzing step for analyzing an output signal of the image input unit so as to output photograph information perception data quantitatively associated with predetermined perception language relating to photograph information;
a photograph information perception data storing step for storing the photograph information perception data in a photograph information perception data storage unit;
a color perception analyzing step for analyzing the output signal of the image input unit so as to output color perception data quantitatively associated with predetermined perception language relating to colors;
a color perception data storing step for storing the color perception data in a color perception data storage unit; and
an image data storing step for storing, in an image data storage unit, image data corresponding to the image content language data, the photograph information perception data and the color perception data, and
wherein the image storage/retrieval program allows the image retrieval apparatus to execute:
a search language input step for inputting search language for search and retrieval;
an image content language data narrowing step for comparing the image content language data stored in the image content language data storage unit with the search language input from the search language input unit so as to extract image content language data at least partially matching the search language; and
an image data output step for extracting and outputting images stored in the image data storage unit in descending order of priority of perception language corresponding to the search language with reference to the photograph information perception data and the color perception data attributed to retrieval target images and including the image content language data narrowed by the image content language data narrowing step.
